(19) United States
(12) Patent Application Publication
(10) Pub. No.: US 2025/0380014 A1
(43) Pub. Date: Dec. 11, 2025

(54) SYSTEM AND METHOD FOR INTERNET OF THINGS (IOT) CAMERA SECURITY

(71) Applicants: SCOTT BARTLET, Oakland, CA (US); BRET JORDAN, Salt Lake City, UT (US); CHRIS AIUTO, San Francisco, CA (US); RAUL IZAHI LOPEZ HERNANDEZ, San Jose, CA (US); CHRISTOPHE JUNCKER, Milpitas, CA (US); KERRY QUINN, Santa Cruz, CA (US)

(72) Inventors: SCOTT BARTLET, Oakland, CA (US); BRET JORDAN, Salt Lake City, UT (US); CHRIS AIUTO, San Francisco, CA (US); RAUL IZAHI LOPEZ HERNANDEZ, San Jose, CA (US); CHRISTOPHE JUNCKER, Milpitas, CA (US); KERRY QUINN, Santa Cruz, CA (US)

(73) Assignee: Afero, Inc., Los Altos, CA (US)

(21) Appl. No.: 19/221,359

(22) Filed: May 28, 2025

Related U.S. Application Data
(60) Provisional application No. 63/657,620, filed on Jun. 7, 2024.

(51) Int. Cl. H04N 21/2347; H04L 9/08; H04N 21/2187; H04N 21/4405

(52) U.S. Cl. CPC H04N 21/2347; H04L 9/0825; H04N 21/2187; H04N 21/4405

(57) ABSTRACT

System and method for securely managing video captured by the IoT cameras. For example, one embodiment of a method comprises: generating a key pair comprising a private key and a public key; storing at least the private key on a data processing device of a user and storing only the public key on an internet of things (IoT) camera associated with an account of the user; in response to an event, the IoT camera to perform the operations of: generating a temporary data encryption key (DEK); encrypting video captured by the camera using the DEK to generated encrypted video blocks; encrypting the DEK using the public key to generate an encrypted DEK; and transmitting the encrypted video blocks and the encrypted DEK to a video storage service.

### BACKGROUND

### Field of the Invention

This invention relates generally to the field of computer systems. More particularly, the invention relates to a system and method for IoT camera security.

### Description of the Related Art

The “Internet of Things” refers to the interconnection of uniquely-identifiable embedded devices within the Internet infrastructure. Ultimately, IoT is expected to result in new, wide-ranging types of applications in which virtually any type of physical thing may provide information about itself or its surroundings and/or may be controlled remotely via client devices over the Internet.

### BRIEF DESCRIPTION OF THE DRAWINGS

A better understanding of the present invention can be obtained from the following detailed description in conjunction with the following drawings, in which:

FIGS. 1A-B illustrates different embodiments of an IoT system architecture;

FIG. 2 illustrates an IoT device in accordance with one embodiment of the invention;

FIG. 3 illustrates an IoT hub in accordance with one embodiment of the invention;

FIG. 4A-B illustrate embodiments of the invention for controlling and collecting data from IoT devices, and generating notifications;

FIG. 5 illustrates embodiments of the invention for collecting data from IoT devices and generating notifications from an IoT hub and/or IoT service;

FIG. 6 illustrates one embodiment of a system in which an intermediary mobile device collects data from a stationary IoT device and provides the data to an IoT hub;

FIG. 7 illustrates intermediary connection logic implemented in one embodiment of the invention;

FIG. 8 illustrates a method in accordance with one embodiment of the invention;

FIG. 9A illustrates an embodiment in which program code and data updates are provided to the IoT device;

FIG. 9B illustrates an embodiment of a method in which program code and data updates are provided to the IoT device;

FIG. 10 illustrates a high level view of one embodiment of a security architecture;

FIG. 11 illustrates one embodiment of an architecture in which a subscriber identity module (SIM) is used to store keys on IoT devices;

FIG. 12A illustrates one embodiment in which IoT devices are registered using barcodes or QR codes;

FIG. 12B illustrates one embodiment in which pairing is performed using barcodes or QR codes;

FIG. 13 illustrates one embodiment of a method for programming a SIM using an IoT hub;

FIG. 14 illustrates one embodiment of a method for registering an IoT device with an IoT hub and IoT service; and

FIG. 15 illustrates one embodiment of a method for encrypting data to be transmitted to an IoT device;

FIGS. 16A-B illustrate different embodiments of the invention for encrypting data between an IoT service and an IoT device;

FIG. 17 illustrates embodiments of the invention for performing a secure key exchange, generating a common secret, and using the secret to generate a key stream;

FIG. 18 illustrates a packet structure in accordance with one embodiment of the invention;

FIG. 19 illustrates techniques employed in one embodiment for writing and reading data to/from an IoT device without formally pairing with the IoT device;

FIG. 20 illustrates an exemplary set of command packets employed in one embodiment of the invention;

FIG. 21 illustrates an exemplary sequence of transactions using command packets;

FIG. 22 illustrates a method in accordance with one embodiment of the invention;

FIGS. 23A-C illustrate a method for secure pairing in accordance with one embodiment of the invention;

FIG. 24 illustrates an example of non-electronic or unpowered (i.e., “passive”) device validation;

FIG. 25 illustrates multiple layers of signatures forming a chain of trust;

FIG. 26 illustrates an embodiment of a factory authenticator which has been authenticated to operate in a factory;

FIGS. 27A-B illustrates a method in accordance with an embodiment of the invention;

FIG. 28 illustrates one embodiment for pairing a peripheral with a computer or mobile device;

FIG. 29 illustrates one embodiment of a sequence of transactions for pairing a peripheral with a computer or mobile device;

FIG. 30 illustrates one embodiment of the invention for pairing a headset with a multimedia system;

FIG. 31 illustrates one embodiment of a system for separately encrypting video from cameras using per-camera session keys;

FIG. 32 illustrates one embodiment of a system for using a temporary session key to share video;

FIG. 33 illustrates another embodiment of a system for using a temporary session key to share video;

FIG. 34 illustrates one embodiment of a system for securely recording and playing back video captured by one or more IoT cameras;

FIG. 35 illustrates one embodiment in which a third party data storage service is used by the IoT service to store captured video; and

FIG. 36 illustrates an embodiment for rendering a live video stream and encrypting video on a data processing device.

### DETAILED DESCRIPTION

In the following description, for the purposes of explanation, numerous specific details are set forth in order to provide a thorough understanding of the embodiments of the invention described below. It will be apparent, however, to one skilled in the art that the embodiments of the invention may be practiced without some of these specific details. In other instances, well-known structures and devices are shown in block diagram form to avoid obscuring the underlying principles of the embodiments of the invention.

One embodiment of the invention comprises an Internet of Things (IoT) platform which may be utilized by developers to design and build new IoT devices and applications. In particular, one embodiment includes a base hardware/software platform for IoT devices including a predefined networking protocol stack and an IoT hub through which the IoT devices are coupled to the Internet. In addition, one embodiment includes an IoT service through which the IoT hubs and connected IoT devices may be accessed and managed as described below. In addition, one embodiment of the IoT platform includes an IoT app or Web application (e.g., executed on a client device) to access and configured the IoT service, hub and connected devices. Existing online retailers and other Website operators may leverage the IoT platform described herein to readily provide unique IoT functionality to existing user bases.

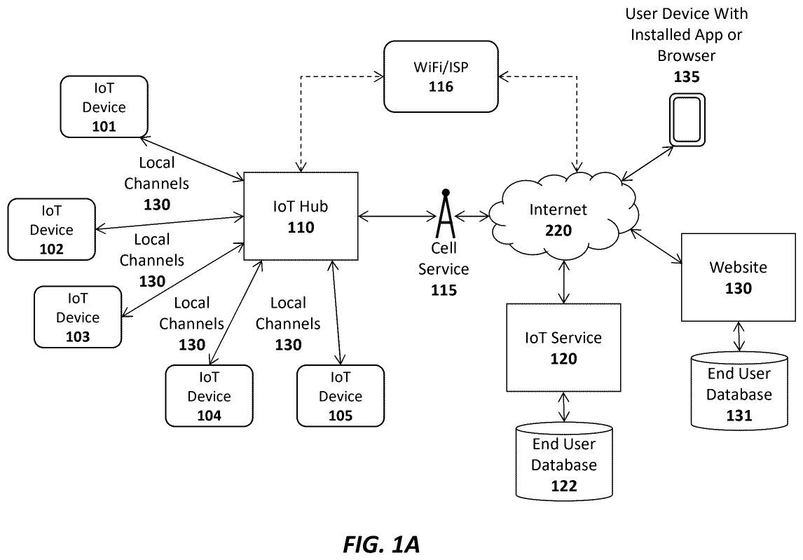

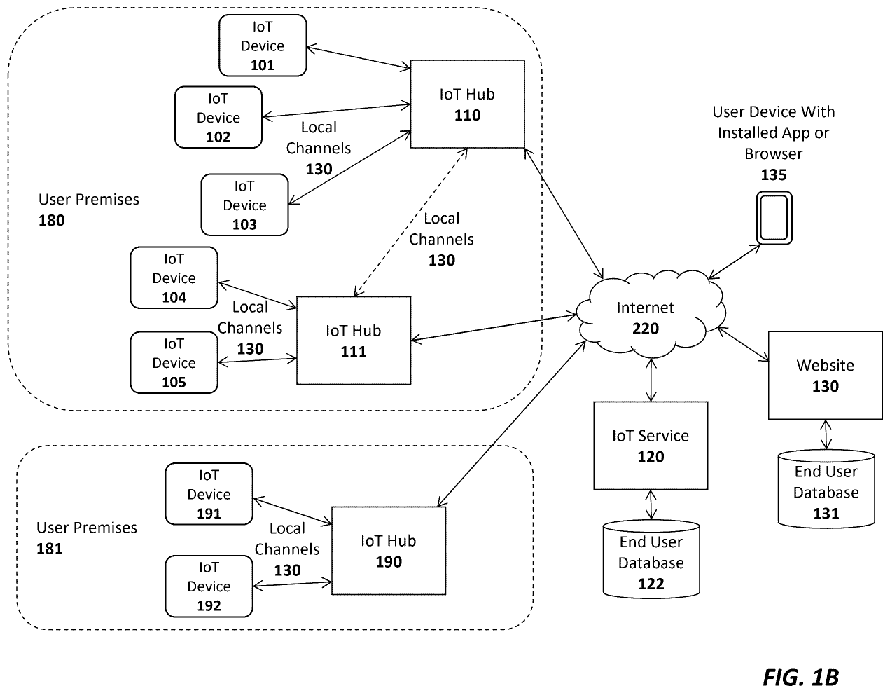

FIG. 1A illustrates an overview of an architectural platform on which embodiments of the invention may be implemented. In particular, the illustrated embodiment includes a plurality of IoT devices 101-105 communicatively coupled over local communication channels 130 to a central IoT hub 110 which is itself communicatively coupled to an IoT service 120 over the Internet 220. Each of the IoT devices 101-105 may initially be paired to the IoT hub 110 (e.g., using the pairing techniques described below) in order to enable each of the local communication channels 130. In one embodiment, the IoT service 120 includes an end user database 122 for maintaining user account information and data collected from each user's IoT devices. For example, if the IoT devices include sensors (e.g., temperature sensors, accelerometers, heat sensors, motion detectore, etc), the database 122 may be continually updated to store the data collected by the IoT devices 101-105. The data stored in the database 122 may then be made accessible to the end user via the IoT app or browser installed on the user's device 135 (or via a desktop or other client computer system) and to web clients (e.g., such as websites 130 subscribing to the IoT service 120

The IoT devices 101-105 may be equipped with various types of sensors to collect information about themselves and their surroundings and provide the collected information to the IoT service 120, user devices 135 and/or external Websites 130 via the IoT hub 110. Some of the IoT devices 101-105 may perform a specified function in response to control commands sent through the IoT hub 110. Various specific examples of information collected by the IoT devices 101-105 and control commands are provided below. In one embodiment described below, the IoT device 101 is a user input device designed to record user selections and send the user selections to the IoT service 120 and/or Website.

In one embodiment, the IoT hub 110 includes a cellular radio to establish a connection to the Internet 220 via a cellular service 115 such as a 4G (e.g., Mobile WiMAX, LTE) or 5G cellular data service. Alternatively, or in addition, the IoT hub 110 may include a WiFi radio to establish a WiFi connection through a WiFi access point or router 116 which couples the IoT hub 110 to the Internet (e.g., via an Internet Service Provider providing Internet service to the end user). Of course, it should be noted that the underlying principles of the invention are not limited to any particular type of communication channel or protocol.

In one embodiment, the IoT devices 101-105 are ultra low-power devices capable of operating for extended periods of time on battery power (e.g., years). To conserve power, the local communication channels 130 may be implemented using a low-power wireless communication technology such as Bluetooth Low Energy (LE). In this embodiment, each of the IoT devices 101-105 and the IoT hub 110 are equipped with Bluetooth LE radios and protocol stacks.

As mentioned, in one embodiment, the IoT platform includes an IoT app or Web application executed on user devices 135 to allow users to access and configure the connected IoT devices 101-105, IoT hub 110, and/or IoT service 120. In one embodiment, the app or web application may be designed by the operator of a Website 130 to provide IoT functionality to its user base. As illustrated, the Website may maintain a user database 131 containing account records related to each user.

FIG. 1B illustrates additional connection options for a plurality of IoT hubs 110-111, 190 In this embodiment a single user may have multiple hubs 110-111 installed onsite at a single user premises 180 (e.g., the user's home or business). This may be done, for example, to extend the wireless range needed to connect all of the IoT devices 101-105. As indicated, if a user has multiple hubs 110, 111 they may be connected via a local communication channel (e.g., Wifi, Ethernet, Power Line Networking, etc). In one embodiment, each of the hubs 110-111 may establish a direct connection to the IoT service 120 through a cellular 115 or WiFi 116 connection (not explicitly shown in FIG. 1B). Alternatively, or in addition, one of the IoT hubs such as IoT hub 110 may act as a “master” hub which provides connectivity and/or local services to all of the other IoT hubs on the user premises 180, such as IoT hub 111 (as indicated by the dotted line connecting IoT hub 110 and IoT hub 111). For example, the master IoT hub 110 may be the only IoT hub to establish a direct connection to the IoT service 120. In one embodiment, only the “master” IoT hub 110 is equipped with a cellular communication interface to establish the connection to the IoT service 120. As such, all communication between the IoT service 120 and the other IoT hubs 111 will flow through the master IoT hub 110. In this role, the master IoT hub 110 may be provided with additional program code to perform filtering operations on the data exchanged between the other IoT hubs 111 and IoT service 120 (e.g., servicing some data requests locally when possible).

Regardless of how the IoT hubs 110-111 are connected, in one embodiment, the IoT service 120 will logically associate the hubs with the user and combine all of the attached IoT devices 101-105 under a single comprehensive user interface, accessible via a user device with the installed app 135 (and/or a browser-based interface).

In this embodiment, the master IoT hub 110 and one or more slave IoT hubs 111 may connect over a local network which may be a WiFi network 116, an Ethernet network, and/or a using power-line communications (PLC) networking (e.g., where all or portions of the network are run through the user's power lines). In addition, to the IoT hubs 110-111, each of the IoT devices 101-105 may be interconnected with the IoT hubs 110-111 using any type of local network channel such as WiFi, Ethernet, PLC, or Bluetooth LE, to name a few.

FIG. 1B also shows an IoT hub 190 installed at a second user premises 181. A virtually unlimited number of such IoT hubs 190 may be installed and configured to collect data from IoT devices 191-192 at user premises around the world. In one embodiment, the two user premises 180-181 may be configured for the same user. For example, one user premises 180 may be the user's primary home and the other user premises 181 may be the user's vacation home. In such a case, the IoT service 120 will logically associate the IoT hubs 110-111, 190 with the user and combine all of the attached IoT devices 101-105, 191-192 under a single comprehensive user interface, accessible via a user device with the installed app 135 (and/or a browser-based interface).

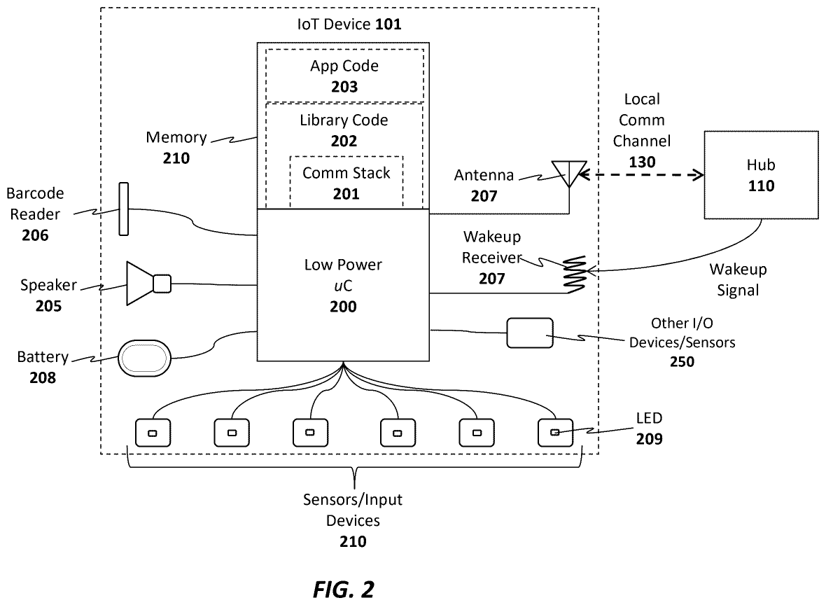

As illustrated in FIG. 2, an exemplary embodiment of an IoT device 101 includes a memory 210 for storing program code and data 201-203 and a low power microcontroller 200 for executing the program code and processing the data. The memory 210 may be a volatile memory such as dynamic random access memory (DRAM) or may be a non-volatile memory such as Flash memory. In one embodiment, a non-volatile memory may be used for persistent storage and a volatile memory may be used for execution of the program code and data at runtime. Moreover, the memory 210 may be integrated within the low power microcontroller 200 or may be coupled to the low power microcontroller 200 via a bus or communication fabric. The underlying principles of the invention are not limited to any particular implementation of the memory 210.

As illustrated, the program code may include application program code 203 defining an application-specific set of functions to be performed by the IoT device 201 and library code 202 comprising a set of predefined building blocks which may be utilized by the application developer of the IoT device 101. In one embodiment, the library code 202 comprises a set of basic functions required to implement an IoT device such as a communication protocol stack 201 for enabling communication between each IoT device 101 and the IoT hub 110. As mentioned, in one embodiment, the communication protocol stack 201 comprises a Bluetooth LE protocol stack. In this embodiment, Bluetooth LE radio and antenna 207 may be integrated within the low power microcontroller 200. However, the underlying principles of the invention are not limited to any particular communication protocol.

The particular embodiment shown in FIG. 2 also includes a plurality of input devices or sensors 210 to receive user input and provide the user input to the low power microcontroller, which processes the user input in accordance with the application code 203 and library code 202. In one embodiment, each of the input devices include an LED 209 to provide feedback to the end user.

In addition, the illustrated embodiment includes a battery 208 for supplying power to the low power microcontroller. In one embodiment, a non-chargeable coin cell battery is used. However, in an alternate embodiment, an integrated rechargeable battery may be used (e.g., rechargeable by connecting the IoT device to an AC power supply (not shown)).

A speaker 205 is also provided for generating audio. In one embodiment, the low power microcontroller 299 includes audio decoding logic for decoding a compressed audio stream (e.g., such as an MPEG-4/Advanced Audio Coding (AAC) stream) to generate audio on the speaker 205. Alternatively, the low power microcontroller 200 and/or the application code/data 203 may include digitally sampled snippets of audio to provide verbal feedback to the end user as the user enters selections via the input devices 210.

In one embodiment, one or more other/alternate I/O devices or sensors 250 may be included on the IoT device 101 based on the particular application for which the IoT device 101 is designed. For example, an environmental sensor may be included to measure temperature, pressure, humidity, etc. A security sensor and/or door lock opener may be included if the IoT device is used as a security device. Of course, these examples are provided merely for the purposes of illustration. The underlying principles of the invention are not limited to any particular type of IoT device. In fact, given the highly programmable nature of the low power microcontroller 200 equipped with the library code 202, an application developer may readily develop new application code 203 and new I/O devices 250 to interface with the low power microcontroller for virtually any type of IoT application.

In one embodiment, the low power microcontroller 200 also includes a secure key store for storing encryption keys for encrypting communications and/or generating signatures. Alternatively, the keys may be secured in a subscriber identify module (SIM).

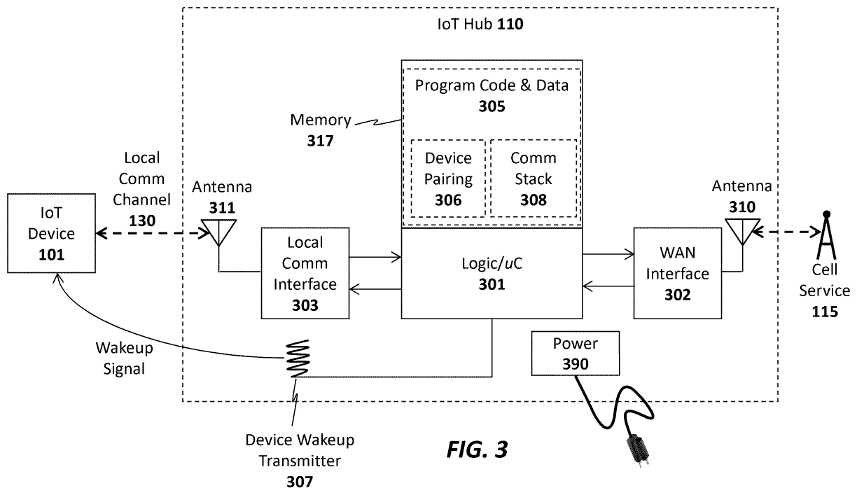

A wakeup receiver 207 is included in one embodiment to wake the IoT device from an ultra low power state in which it is consuming virtually no power. In one embodiment, the wakeup receiver 207 is configured to cause the IoT device 101 to exit this low power state in response to a wakeup signal received from a wakeup transmitter 307 configured on the IoT hub 110 as shown in FIG. 3. In particular, in one embodiment, the transmitter 307 and receiver 207 together form an electrical resonant transformer circuit such as a Tesla coil. In operation, energy is transmitted via radio frequency signals from the transmitter 307 to the receiver 207 when the hub 110 needs to wake the IoT device 101 from a very low power state. Because of the energy transfer, the IoT device 101 may be configured to consume virtually no power when it is in its low power state because it does not need to continually “listen” for a signal from the hub (as is the case with network protocols which allow devices to be awakened via a network signal). Rather, the microcontroller 200 of the IoT device 101 may be configured to wake up after being effectively powered down by using the energy electrically transmitted from the transmitter 307 to the receiver 207.

As illustrated in FIG. 3, the IoT hub 110 also includes a memory 317 for storing program code and data 305 and hardware logic 301 such as a microcontroller for executing the program code and processing the data. A wide area network (WAN) interface 302 and antenna 310 couple the IoT hub 110 to the cellular service 115. Alternatively, as mentioned above, the IoT hub 110 may also include a local network interface (not shown) such as a WiFi interface (and WiFi antenna) or Ethernet interface for establishing a local area network communication channel. In one embodiment, the hardware logic 301 also includes a secure key store for storing encryption keys for encrypting communications and generating/verifying signatures. Alternatively, the keys may be secured in a subscriber identify module (SIM).

A local communication interface 303 and antenna 311 establishes local communication channels with each of the IoT devices 101-105. As mentioned above, in one embodiment, the local communication interface 303/antenna 311 implements the Bluetooth LE standard. However, the underlying principles of the invention are not limited to any particular protocols for establishing the local communication channels with the IoT devices 101-105. Although illustrated as separate units in FIG. 3, the WAN interface 302 and/or local communication interface 303 may be embedded within the same chip as the hardware logic 301.

In one embodiment, the program code and data includes a communication protocol stack 308 which may include separate stacks for communicating over the local communication interface 303 and the WAN interface 302. In addition, device pairing program code and data 306 may be stored in the memory to allow the IoT hub to pair with new IoT devices. In one embodiment, each new IoT device 101-105 is assigned a unique code which is communicated to the IoT hub 110 during the pairing process. For example, the unique code may be embedded in a barcode on the IoT device and may be read by the barcode reader 106 or may be communicated over the local communication channel 130. In an alternate embodiment, the unique ID code is embedded magnetically on the IoT device and the IoT hub has a magnetic sensor such as an radio frequency ID (RFID) or near field communication (NFC) sensor to detect the code when the IoT device 101 is moved within a few inches of the IoT hub 110.

In one embodiment, once the unique ID has been communicated, the IoT hub 110 may verify the unique ID by querying a local database (not shown), performing a hash to verify that the code is acceptable, and/or communicating with the IoT service 120, user device 135 and/or Website 130 to validate the ID code. Once validated, in one embodiment, the IoT hub 110 pairs the IoT device 101 and stores the pairing data in memory 317 (which, as mentioned, may include non-volatile memory). Once pairing is complete, the IoT hub 110 may connect with the IoT device 101 to perform the various IoT functions described herein.

In one embodiment, the organization running the IoT service 120 may provide the IoT hub 110 and a basic hardware/software platform to allow developers to easily design new IoT services. In particular, in addition to the IoT hub 110, developers may be provided with a software development kit (SDK) to update the program code and data 305 executed within the hub 110. In addition, for IoT devices 101, the SDK may include an extensive set of library code 202 designed for the base IoT hardware (e.g., the low power microcontroller 200 and other components shown in FIG. 2) to facilitate the design of various different types of applications 101. In one embodiment, the SDK includes a graphical design interface in which the developer needs only to specify input and outputs for the IoT device. All of the networking code, including the communication stack 201 that allows the IoT device 101 to connect to the hub 110 and the service 120, is already in place for the developer. In addition, in one embodiment, the SDK also includes a library code base to facilitate the design of apps for mobile devices (e.g., iPhone and Android devices).

In one embodiment, the IoT hub 110 manages a continuous bi-directional stream of data between the IoT devices 101-105 and the IoT service 120. In circumstances where updates to/from the IoT devices 101-105 are required in real time (e.g., where a user needs to view the current status of security devices or environmental readings), the IoT hub may maintain an open TCP socket to provide regular updates to the user device 135 and/or external Websites 130. The specific networking protocol used to provide updates may be tweaked based on the needs of the underlying application. For example, in some cases, where may not make sense to have a continuous bi-directional stream, a simple request/response protocol may be used to gather information when needed.

In one embodiment, both the IoT hub 110 and the IoT devices 101-105 are automatically upgradeable over the network. In particular, when a new update is available for the IoT hub 110 it may automatically download and install the update from the IoT service 120. It may first copy the updated code into a local memory, run and verify the update before swapping out the older program code. Similarly, when updates are available for each of the IoT devices 101-105, they may initially be downloaded by the IoT hub 110 and pushed out to each of the IoT devices 101-105. Each IoT device 101-105 may then apply the update in a similar manner as described above for the IoT hub and report back the results of the update to the IoT hub 110. If the update is successful, then the IoT hub 110 may delete the update from its memory and record the latest version of code installed on each IoT device (e.g., so that it may continue to check for new updates for each IoT device).

In one embodiment, the IoT hub 110 is powered via A/C power. In particular, the IoT hub 110 may include a power unit 390 with a transformer for transforming A/C voltage supplied via an A/C power cord to a lower DC voltage.

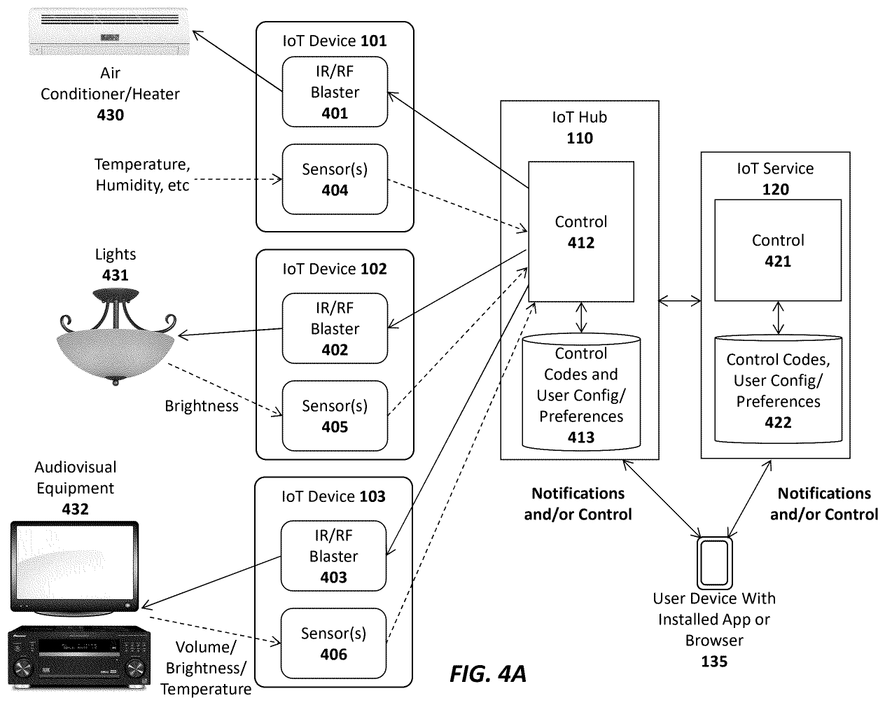

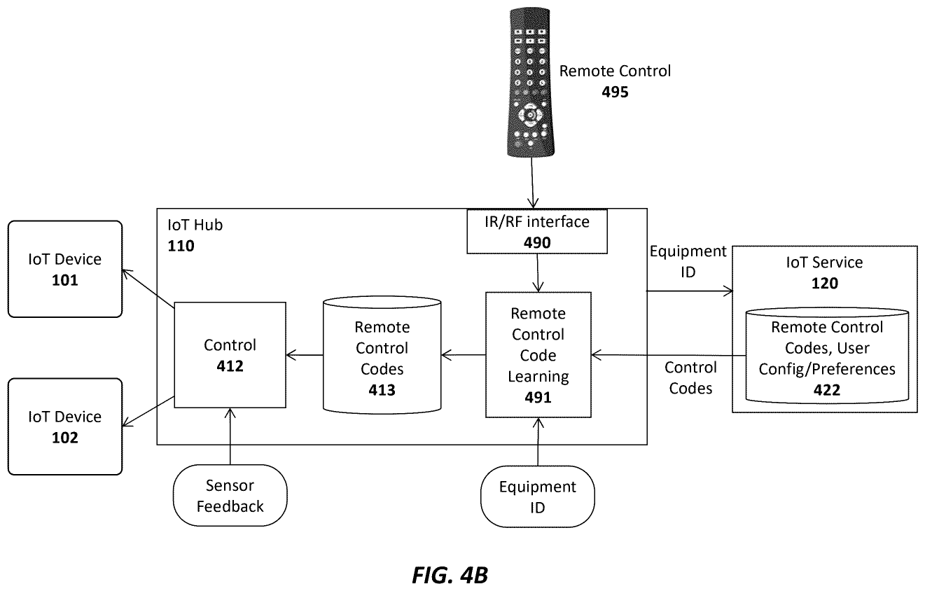

FIG. 4A illustrates one embodiment of the invention for performing universal remote control operations using the IoT system. In particular, in this embodiment, a set of IoT devices 101-103 are equipped with infrared (IR) and/or radio frequency (RF) blasters 401-403, respectively, for transmitting remote control codes to control various different types of electronics equipment including air conditioners/heaters 430, lighting systems 431, and audiovisual equipment 432 (to name just a few). In the embodiment shown in FIG. 4A, the IoT devices 101-103 are also equipped with sensors 404-406, respectively, for detecting the operation of the devices which they control, as described below.

For example, sensor 404 in IoT device 101 may be a temperature and/or humidity sensor for sensing the current temperature/humidity and responsively controlling the air conditioner/heater 430 based on a current desired temperature. In this embodiment, the air conditioner/heater 430 is one which is designed to be controlled via a remote control device (typically a remote control which itself has a temperature sensor embedded therein). In one embodiment, the user provides the desired temperature to the IoT hub 110 via an app or browser installed on a user device 135. Control logic 412 executed on the IoT hub 110 receives the current temperature/humidity data from the sensor 404 and responsively transmits commands to the IoT device 101 to control the IR/RF blaster 401 in accordance with the desired temperature/humidity. For example, if the temperature is below the desired temperature, then the control logic 412 may transmit a command to the air conditioner/heater via the IR/RF blaster 401 to increase the temperature (e.g., either by turning off the air conditioner or turning on the heater). The command may include the necessary remote control code stored in a database 413 on the IoT hub 110. Alternatively, or in addition, the IoT service 421 may implement control logic 421 to control the electronics equipment 430-432 based on specified user preferences and stored control codes 422.

IoT device 102 in the illustrated example is used to control lighting 431. In particular, sensor 405 in IoT device 102 may photosensor or photodetector configured to detect the current brightness of the light being produced by a light fixture 431 (or other lighting apparatus). The user may specify a desired lighting level (including an indication of ON or OFF) to the IoT hub 110 via the user device 135. In response, the control logic 412 will transmit commands to the IR/RF blaster 402 to control the current brightness level of the lights 431 (e.g., increasing the lighting if the current brightness is too low or decreasing the lighting if the current brightness is too high; or simply turning the lights ON or OFF).

IoT device 103 in the illustrated example is configured to control audiovisual equipment 432 (e.g., a television, A/V receiver, cable/satellite receiver, AppleTV™, etc). Sensor 406 in IoT device 103 may be an audio sensor (e.g., a microphone and associated logic) for detecting a current ambient volume level and/or a photosensor to detect whether a television is on or off based on the light generated by the television (e.g., by measuring the light within a specified spectrum). Alternatively, sensor 406 may include a temperature sensor connected to the audiovisual equipment to detect whether the audio equipment is on or off based on the detected temperature. Once again, in response to user input via the user device 135, the control logic 412 may transmit commands to the audiovisual equipment via the IR blaster 403 of the IoT device 103.

It should be noted that the foregoing are merely illustrative examples of one embodiment of the invention. The underlying principles of the invention are not limited to any particular type of sensors or equipment to be controlled by IoT devices.

In an embodiment in which the IoT devices 101-103 are coupled to the IoT hub 110 via a Bluetooth LE connection, the sensor data and commands are sent over the Bluetooth LE channel. However, the underlying principles of the invention are not limited to Bluetooth LE or any other communication standard.

In one embodiment, the control codes required to control each of the pieces of electronics equipment are stored in a database 413 on the IoT hub 110 and/or a database 422 on the IoT service 120. As illustrated in FIG. 4B, the control codes may be provided to the IoT hub 110 from a master database of control codes 422 for different pieces of equipment maintained on the IoT service 120. The end user may specify the types of electronic (or other) equipment to be controlled via the app or browser executed on the user device 135 and, in response, a remote control code learning module 491 on the IoT hub may retrieve the required IR/RF codes from the remote control code database 492 on the IoT service 120 (e.g., identifying each piece of electronic equipment with a unique ID).

In addition, in one embodiment, the IoT hub 110 is equipped with an IR/RF interface 490 to allow the remote control code learning module 491 to “learn” new remote control codes directly from the original remote control 495 provided with the electronic equipment. For example, if control codes for the original remote control provided with the air conditioner 430 is not included in the remote control database, the user may interact with the IoT hub 110 via the app/browser on the user device 135 to teach the IoT hub 110 the various control codes generated by the original remote control (e.g., increase temperature, decrease temperature, etc). Once the remote control codes are learned they may be stored in the control code database 413 on the IoT hub 110 and/or sent back to the IoT service 120 to be included in the central remote control code database 492 (and subsequently used by other users with the same air conditioner unit 430).

In one embodiment, each of the IoT devices 101-103 have an extremely small form factor and may be affixed on or near their respective electronics equipment 430-432 using double-sided tape, a small nail, a magnetic attachment, etc. For control of a piece of equipment such as the air conditioner 430, it would be desirable to place the IoT device 101 sufficiently far away so that the sensor 404 can accurately measure the ambient temperature in the home (e.g., placing the IoT device directly on the air conditioner would result in a temperature measurement which would be too low when the air conditioner was running or too high when the heater was running). In contrast, the IoT device 102 used for controlling lighting may be placed on or near the lighting fixture 431 for the sensor 405 to detect the current lighting level.

In addition to providing general control functions as described, one embodiment of the IoT hub 110 and/or IoT service 120 transmits notifications to the end user related to the current status of each piece of electronics equipment. The notifications, which may be text messages and/or app-specific notifications, may then be displayed on the display of the user's mobile device 135. For example, if the user's air conditioner has been on for an extended period of time but the temperature has not changed, the IoT hub 110 and/or IoT service 120 may send the user a notification that the air conditioner is not functioning properly. If the user is not home (which may be detected via motion sensors or based on the user's current detected location), and the sensors 406 indicate that audiovisual equipment 430 is on or sensors 405 indicate that the lights are on, then a notification may be sent to the user, asking if the user would like to turn off the audiovisual equipment 432 and/or lights 431. The same type of notification may be sent for any equipment type.

Once the user receives a notification, he/she may remotely control the electronics equipment 430-432 via the app or browser on the user device 135. In one embodiment, the user device 135 is a touchscreen device and the app or browser displays an image of a remote control with user-selectable buttons for controlling the equipment 430-432. Upon receiving a notification, the user may open the graphical remote control and turn off or adjust the various different pieces of equipment. If connected via the IoT service 120, the user's selections may be forwarded from the IoT service 120 to the IoT hub 110 which will then control the equipment via the control logic 412. Alternatively, the user input may be sent directly to the IoT hub 110 from the user device 135.

In one embodiment, the user may program the control logic 412 on the IoT hub 110 to perform various automatic control functions with respect to the electronics equipment 430-432. In addition to maintaining a desired temperature, brightness level, and volume level as described above, the control logic 412 may automatically turn off the electronics equipment if certain conditions are detected. For example, if the control logic 412 detects that the user is not home and that the air conditioner is not functioning, it may automatically turn off the air conditioner. Similarly, if the user is not home, and the sensors 406 indicate that audiovisual equipment 430 is on or sensors 405 indicate that the lights are on, then the control logic 412 may automatically transmit commands via the IR/RF blasters 403 and 402, to turn off the audiovisual equipment and lights, respectively.

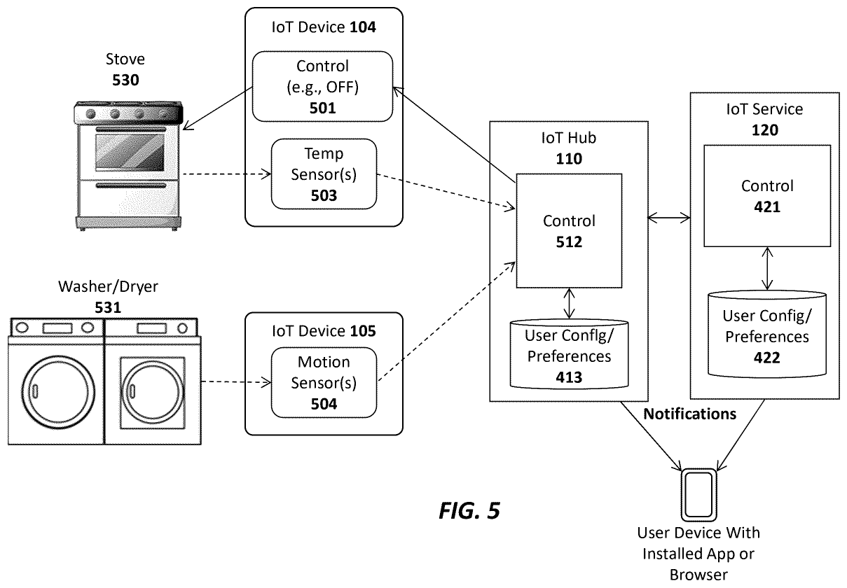

FIG. 5 illustrates additional embodiments of IoT devices 104-105 equipped with sensors 503-504 for monitoring electronic equipment 530-531. In particular, the IoT device 104 of this embodiment includes a temperature sensor 503 which may be placed on or near a stove 530 to detect when the stove has been left on. In one embodiment, the IoT device 104 transmits the current temperature measured by the temperature sensor 503 to the IoT hub 110 and/or the IoT service 120. If the stove is detected to be on for more than a threshold time period (e.g., based on the measured temperature), then control logic 512 may transmit a notification to the end user's device 135 informing the user that the stove 530 is on. In addition, in one embodiment, the IoT device 104 may include a control module 501 to turn off the stove, either in response to receiving an instruction from the user or automatically (if the control logic 512 is programmed to do so by the user). In one embodiment, the control logic 501 comprises a switch to cut off electricity or gas to the stove 530. However, in other embodiments, the control logic 501 may be integrated within the stove itself.

FIG. 5 also illustrates an IoT device 105 with a motion sensor 504 for detecting the motion of certain types of electronics equipment such as a washer and/or dryer. Another sensor that may be used is an audio sensor (e.g., microphone and logic) for detecting an ambient volume level. As with the other embodiments described above, this embodiment may transmit notifications to the end user if certain specified conditions are met (e.g., if motion is detected for an extended period of time, indicating that the washer/dryer are not turning off). Although not shown in FIG. 5, IoT device 105 may also be equipped with a control module to turn off the washer/dryer 531 (e.g., by switching off electric/gas), automatically, and/or in response to user input.

In one embodiment, a first IoT device with control logic and a switch may be configured to turn off all power in the user's home and a second IoT device with control logic and a switch may be configured to turn off all gas in the user's home. IoT devices with sensors may then be positioned on or near electronic or gas-powered equipment in the user's home. If the user is notified that a particular piece of equipment has been left on (e.g., the stove 530), the user may then send a command to turn off all electricity or gas in the home to prevent damage. Alternatively, the control logic 512 in the IoT hub 110 and/or the IoT service 120 may be configured to automatically turn off electricity or gas in such situations.

In one embodiment, the IoT hub 110 and IoT service 120 communicate at periodic intervals. If the IoT service 120 detects that the connection to the IoT hub 110 has been lost (e.g., by failing to receive a request or response from the IoT hub for a specified duration), it will communicate this information to the end user's device 135 (e.g., by sending a text message or app-specific notification).

### Apparatus and Method for Communicating Data Through an Intermediary Device

As mentioned above, because the wireless technologies used to interconnect IoT devices such as Bluetooth LE are generally short range technologies, if the hub for an IoT implementation is outside the range of an IoT device, the IoT device will not be able to transmit data to the IoT hub (and vice versa).

To address this deficiency, one embodiment of the invention provides a mechanism for an IoT device which is outside of the wireless range of the IoT hub to periodically connect with one or more mobile devices when the mobile devices are within range. Once connected, the IoT device can transmit any data which needs to be provided to the IoT hub to the mobile device which then forwards the data to the IoT hub.

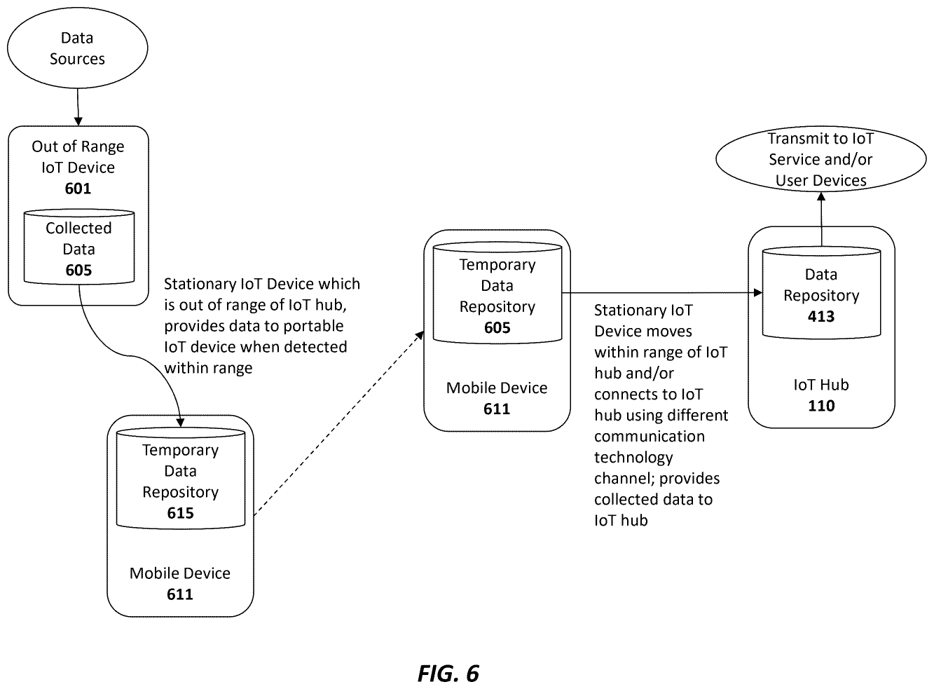

As illustrated in FIG. 6 one embodiment includes an IoT hub 110, an IoT device 601 which is out of range of the IoT hub 110 and a mobile device 611. The out of range IoT device 601 may include any form of IoT device capable of collecting and communicating data. For example, the IoT device 601 may comprise a data collection device configured within a refrigerator to monitor the food items available in the refrigerator, the users who consume the food items, and the current temperature. Of course, the underlying principles of the invention are not limited to any particular type of IoT device. The techniques described herein may be implemented using any type of IoT device including those used to collect and transmit data for smart meters, stoves, washers, dryers, lighting systems, HVAC systems, and audiovisual equipment, to name just a few.

Moreover, the mobile device In operation, the IoT device 611 illustrated in FIG. 6 may be any form of mobile device capable of communicating and storing data. For example, in one embodiment, the mobile device 611 is a smartphone with an app installed thereon to facilitate the techniques described herein. In another embodiment, the mobile device 611 comprises a wearable device such as a communication token affixed to a neckless or bracelet, a smartwatch or a fitness device. The wearable token may be particularly useful for elderly users or other users who do not own a smartphone device.

In operation, the out of range IoT device 601 may periodically or continually check for connectivity with a mobile device 611. Upon establishing a connection (e.g., as the result of the user moving within the vicinity of the refrigerator) any collected data 605 on the IoT device 601 is automatically transmitted to a temporary data repository 615 on the mobile device 611. In one embodiment, the IoT device 601 and mobile device 611 establish a local wireless communication channel using a low power wireless standard such as BTLE. In such a case, the mobile device 611 may initially be paired with the IoT device 601 using known pairing techniques.

One the data has been transferred to the temporary data repository, the mobile device 611 will transmit the data once communication is established with the IoT hub 110 (e.g., when the user walks within the range of the IoT hub 110). The IoT hub may then store the data in a central data repository 413 and/or send the data over the Internet to one or more services and/or other user devices. In one embodiment, the mobile device 611 may use a different type of communication channel to provide the data to the IoT hub 110 (potentially a higher power communication channel such as WiFi).

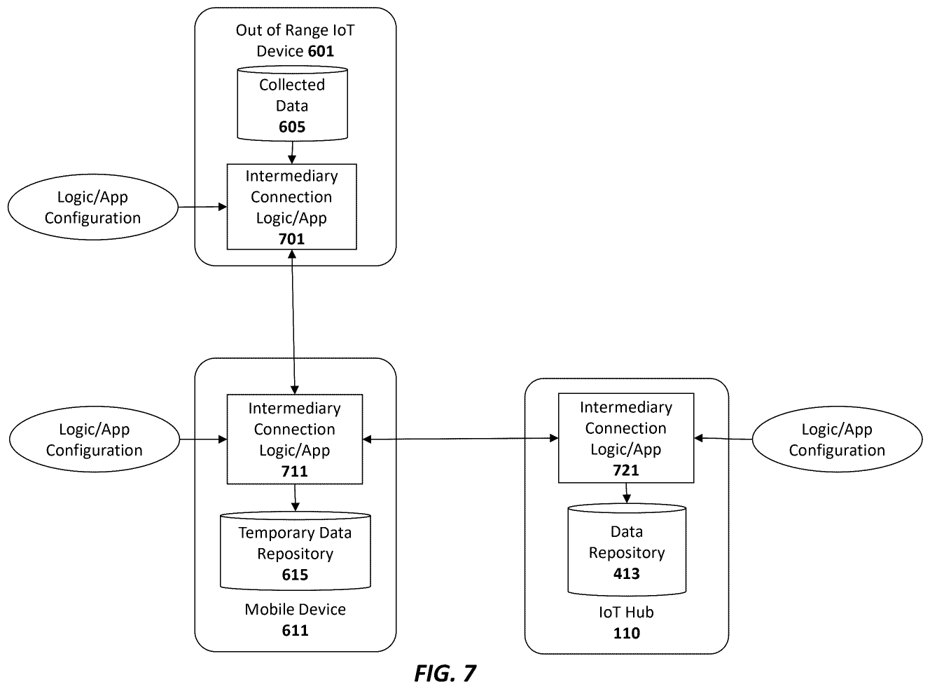

The out of range IoT device 601, the mobile device 611, and the IoT hub may all be configured with program code and/or logic to implement the techniques described herein. As illustrated in FIG. 7, for example, the IoT device 601 may be configured with intermediary connection logic and/or application, the mobile device 611 may be configured with an intermediary connection logic/application, and the IoT hub 110 may be configured with an intermediary connection logic/application 721 to perform the operations described herein. The intermediary connection logic/application on each device may be implemented in hardware, software, or any combination thereof. In one embodiment, the intermediary connection logic/application 701 of the IoT device 601 searches and establishes a connection with the intermediary connection logic/application 711 on the mobile device (which may be implemented as a device app) to transfer the data to the temporary data repository 615. The intermediary connection logic/application 701 on the mobile device 611 then forwards the data to the intermediary connection logic/application on the IoT hub, which stores the data in the central data repository 413.

As illustrated in FIG. 7, the intermediary connection logic/applications 701, 711, 721, on each device may be configured based on the application at hand. For example, for a refrigerator, the connection logic/application 701 may only need to transmit a few packets on a periodic basis. For other applications (e.g., temperature sensors), the connection logic/application 701 may need to transmit more frequent updates.

Rather than a mobile device 611, in one embodiment, the IoT device 601 may be configured to establish a wireless connection with one or more intermediary IoT devices, which are located within range of the IoT hub 110. In this embodiment, any IoT devices 601 out of range of the IoT hub may be linked to the hub by forming a “chain” using other IoT devices.

In addition, while only a single mobile device 611 is illustrated in FIGS. 6-7 for simplicity, in one embodiment, multiple such mobile devices of different users may be configured to communicate with the IoT device 601. Moreover, the same techniques may be implemented for multiple other IoT devices, thereby forming an intermediary device data collection system across the entire home.

Moreover, in one embodiment, the techniques described herein may be used to collect various different types of pertinent data. For example, in one embodiment, each time the mobile device 611 connects with the IoT device 601, the identity of the user may be included with the collected data 605. In this manner, the IoT system may be used to track the behavior of different users within the home. For example, if used within a refrigerator, the collected data 605 may then include the identify of each user who passes by fridge, each user who opens the fridge, and the specific food items consumed by each user. Different types of data may be collected from other types of IoT devices. Using this data the system is able to determine, for example, which user washes clothes, which user watches TV on a given day, the times at which each user goes to sleep and wakes up, etc. All of this crowd-sourced data may then be compiled within the data repository 413 of the IoT hub and/or forwarded to an external service or user.

Another beneficial application of the techniques described herein is for monitoring elderly users who may need assistance. For this application, the mobile device 611 may be a very small token worn by the elderly user to collect the information in different rooms of the user's home. Each time the user opens the refrigerator, for example, this data will be included with the collected data 605 and transferred to the IoT hub 110 via the token. The IoT hub may then provide the data to one or more external users (e.g., the children or other individuals who care for the elderly user). If data has not been collected for a specified period of time (e.g., 12 hours), then this means that the elderly user has not been moving around the home and/or has not been opening the refrigerator. The IoT hub 110 or an external service connected to the IoT hub may then transmit an alert notification to these other individuals, informing them that they should check on the elderly user. In addition, the collected data 605 may include other pertinent information such as the food being consumed by the user and whether a trip to the grocery store is needed, whether and how frequently the elderly user is watching TV, the frequency with which the elderly user washes clothes, etc.

In another implementation, the if there is a problem with an electronic device such as a washer, refrigerator, HVAC system, etc, the collected data may include an indication of a part that needs to be replaced. In such a case, a notification may be sent to a technician with a request to fix the problem. The technician may then arrive at the home with the needed replacement part.

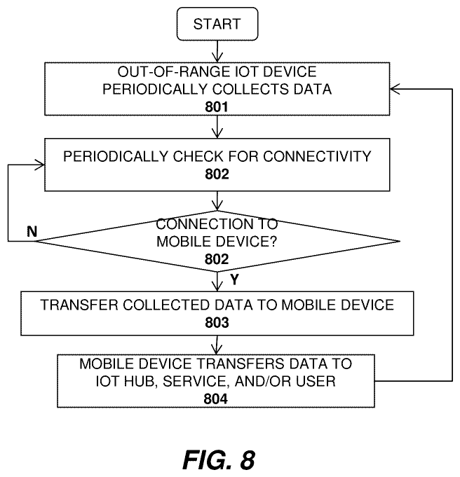

A method in accordance with one embodiment of the invention is illustrated in FIG. 8. The method may be implemented within the context of the architectures described above, but is not limited to any particular architecture.

At 801, an IoT device which is out of range of the IoT hub periodically collects data (e.g., opening of the refrigerator door, food items used, etc). At 802 the IoT device periodically or continually checks for connectivity with a mobile device (e.g., using standard local wireless techniques for establishing a connection such as those specified by the BTLE standard). If the connection to the mobile device is established, determined at 802, then at 803, the collected data is transferred to the mobile device at 803. At 804, the mobile device transfers the data to the IoT hub, an external service and/or a user. As mentioned, the mobile device may transmit the data immediately if it is already connected (e.g., via a WiFi link).

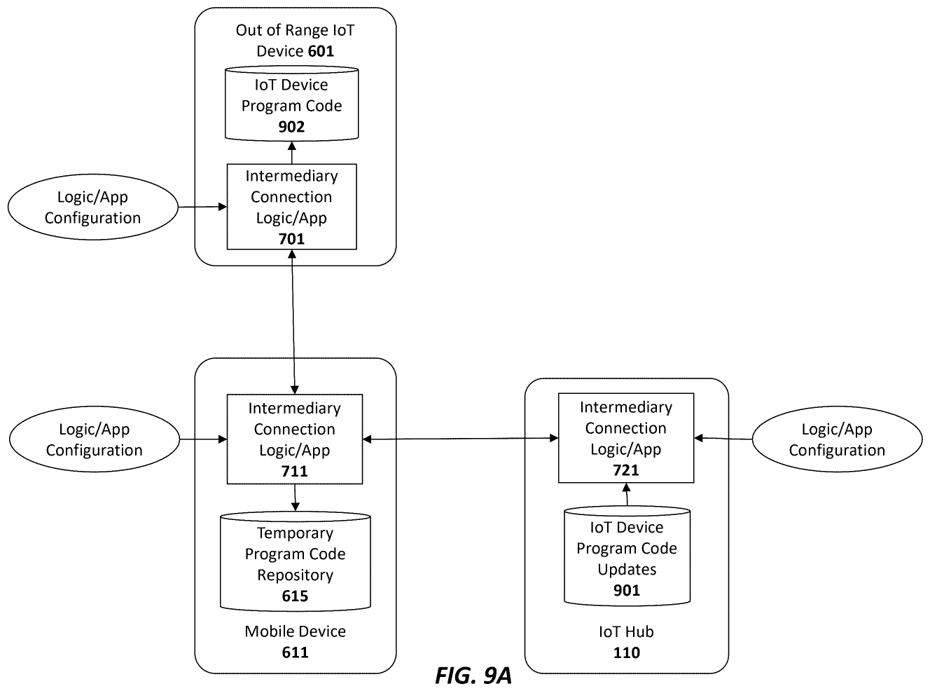

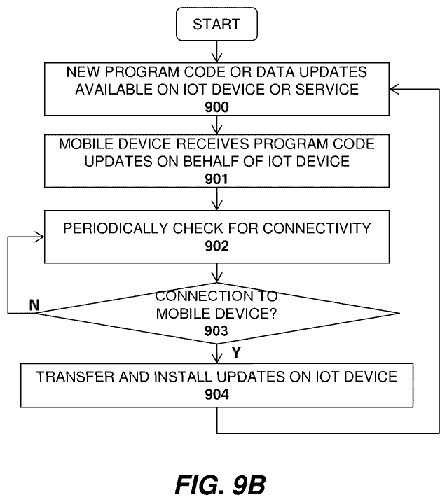

In addition to collecting data from IoT devices, in one embodiment, the techniques described herein may be used to update or otherwise provide data to IoT devices. One example is shown in FIG. 9A, which shows an IoT hub 110 with program code updates 901 that need to be installed on an IoT device 601 (or a group of such IoT devices). The program code updates may include system updates, patches, configuration data and any other data needed for the IoT device to operate as desired by the user. In one embodiment, the user may specify configuration options for the IoT device 601 via a mobile device or computer which are then stored on the IoT hub 110 and provided to the IoT device using the techniques described herein. Specifically, in one embodiment, the intermediary connection logic/application 721 on the IoT hub 110 communicates with the intermediary connection logic/application 711 on the mobile device 611 to store the program code updates within a temporary storage 615. When the mobile device 611 enters the range of the IoT device 601, the intermediary connection logic/application 711 on the mobile device 611 connects with the intermediary/connection logic/application 701 on the IoT device 601 to provide the program code updates to the device. In one embodiment, the IoT device 601 may then enter into an automated update process to install the new program code updates and/or data.

A method for updating an IoT device is shown in FIG. 9B. The method may be implemented within the context of the system architectures described above, but is not limited to any particular system architectures.

At 900 new program code or data updates are made available on the IoT hub and/or an external service (e.g., coupled to the mobile device over the Internet). At 901, the mobile device receives and stores the program code or data updates on behalf of the IoT device. The IoT device and/or mobile device periodically check to determine whether a connection has been established at 902. If a connection is established, determined at 903, then at 904 the updates are transferred to the IoT device and installed.

### Embodiments for Improved Security

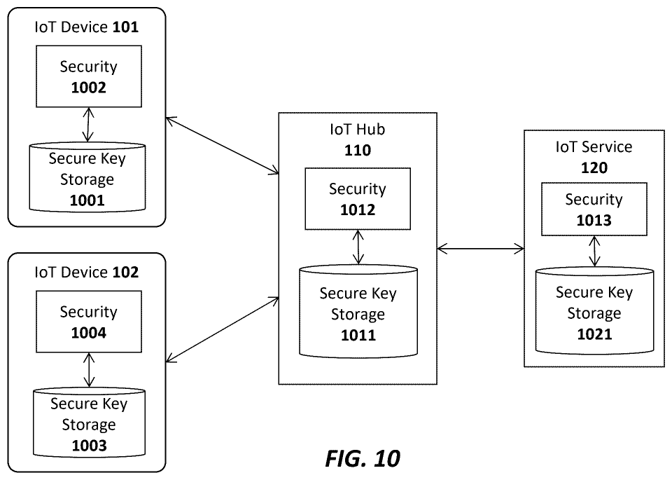

In one embodiment, the low power microcontroller 200 of each IoT device 101 and the low power logic/microcontroller 301 of the IoT hub 110 include a secure key store for storing encryption keys used by the embodiments described below (see, e.g., FIGS. 10-15 and associated text). Alternatively, the keys may be secured in a subscriber identify module (SIM) as discussed below.

FIG. 10 illustrates a high level architecture which uses public key infrastructure (PKI) techniques and/or symmetric key exchange/encryption techniques to encrypt communications between the IoT Service 120, the IoT hub 110 and the IoT devices 101-102.

Embodiments which use public/private key pairs will first be described, followed by embodiments which use symmetric key exchange/encryption techniques. In particular, in an embodiment which uses PKI, a unique public/private key pair is associated with each IoT device 101-102, each IoT hub 110 and the IoT service 120. In one embodiment, when a new IoT hub 110 is set up, its public key is provided to the IoT service 120 and when a new IoT device 101 is set up, it's public key is provided to both the IoT hub 110 and the IoT service 120. Various techniques for securely exchanging the public keys between devices are described below. In one embodiment, all public keys are signed by a master key known to all of the receiving devices (i.e., a form of certificate) so that any receiving device can verify the validity of the public keys by validating the signatures. Thus, these certificates would be exchanged rather than merely exchanging the raw public keys.

As illustrated, in one embodiment, each IoT device 101, 102 includes a secure key storage 1001, 1003, respectively, for security storing each device's private key. Security subsystem 1002, 1304 then utilizes the securely stored private keys to perform the encryption/decryption operations described herein. Similarly, the IoT hub 110 includes a secure storage 1011 for storing the IoT hub private key and the public keys of the IoT devices 101-102 and the IoT service 120; as well as security subsystem 1012 for using the keys to perform encryption/decryption operations. Finally, the IoT service 120 may include a secure storage 1021 for security storing its own private key, the public keys of various IoT devices and IoT hubs, and a security subsystem 1013 for using the keys to encrypt/decrypt communication with IoT hubs and devices. In one embodiment, when the IoT hub 110 receives a public key certificate from an IoT device it can verify it (e.g., by validating the signature using the master key as described above), and then extract the public key from within it and store that public key in it's secure key store 1011.

By way of example, in one embodiment, when the IoT service 120 needs to transmit a command or data to an IoT device 101 (e.g., a command to unlock a door, a request to read a sensor, data to be processed/displayed by the IoT device, etc) the security subsystem 1013 encrypts the data/command using the public key of the IoT device 101 to generate an encrypted IoT device packet. In one embodiment, it then encrypts the IoT device packet using the public key of the IoT hub 110 to generate an IoT hub packet and transmits the IoT hub packet to the IoT hub 110. In one embodiment, the service 120 signs the encrypted message with it's private key or the master key mentioned above so that the device 101 can verify it is receiving an unaltered message from a trusted source. The device 101 may then validate the signature using the public key corresponding to the private key and/or the master key. As mentioned above, symmetric key exchange/encryption techniques may be used instead of public/private key encryption. In these embodiments, rather than privately storing one key and providing a corresponding public key to other devices, the devices may each be provided with a copy of the same symmetric key to be used for encryption and to validate signatures. One example of a symmetric key algorithm is the Advanced Encryption Standard (AES), although the underlying principles of the invention are not limited to any type of specific symmetric keys.

Using a symmetric key implementation, each device 101 enters into a secure key exchange protocol to exchange a symmetric key with the IoT hub 110. A secure key provisioning protocol such as the Dynamic Symmetric Key Provisioning Protocol (DSKPP) may be used to exchange the keys over a secure communication channel (see, e.g., Request for Comments (RFC) 6063). However, the underlying principles of the invention are not limited to any particular key provisioning protocol.

Once the symmetric keys have been exchanged, they may be used by each device 101 and the IoT hub 110 to encrypt communications. Similarly, the IoT hub 110 and IoT service 120 may perform a secure symmetric key exchange and then use the exchanged symmetric keys to encrypt communications. In one embodiment a new symmetric key is exchanged periodically between the devices 101 and the hub 110 and between the hub 110 and the IoT service 120. In one embodiment, a new symmetric key is exchanged with each new communication session between the devices 101, the hub 110, and the service 120 (e.g., a new key is generated and securely exchanged for each communication session). In one embodiment, if the security module 1012 in the IoT hub is trusted, the service 120 could negotiate a session key with the hub security module 1312 and then the security module 1012 would negotiate a session key with each device 120. Messages from the service 120 would then be decrypted and verified in the hub security module 1012 before being re-encrypted for transmission to the device 101.

In one embodiment, to prevent a compromise on the hub security module 1012 a one-time (permanent) installation key may be negotiated between the device 101 and service 120 at installation time. When sending a message to a device 101 the service 120 could first encrypt/MAC with this device installation key, then encrypt/MAC that with the hub's session key. The hub 110 would then verify and extract the encrypted device blob and send that to the device.

In one embodiment of the invention, a counter mechanism is implemented to prevent replay attacks. For example, each successive communication from the device 101 to the hub 110 (or vice versa) may be assigned a continually increasing counter value. Both the hub 110 and device 101 will track this value and verify that the value is correct in each successive communication between the devices. The same techniques may be implemented between the hub 110 and the service 120. Using a counter in this manner would make it more difficult to spoof the communication between each of the devices (because the counter value would be incorrect). However, even without this a shared installation key between the service and device would prevent network (hub) wide attacks to all devices.

In one embodiment, when using public/private key encryption, the IoT hub 110 uses its private key to decrypt the IoT hub packet and generate the encrypted IoT device packet, which it transmits to the associated IoT device 101. The IoT device 101 then uses its private key to decrypt the IoT device packet to generate the command/data originated from the IoT service 120. It may then process the data and/or execute the command. Using symmetric encryption, each device would encrypt and decrypt with the shared symmetric key. If either case, each transmitting device may also sign the message with it's private key so that the receiving device can verify it's authenticity.

A different set of keys may be used to encrypt communication from the IoT device 101 to the IoT hub 110 and to the IoT service 120. For example, using a public/private key arrangement, in one embodiment, the security subsystem 1002 on the IoT device 101 uses the public key of the IoT hub 110 to encrypt data packets sent to the IoT hub 110. The security subsystem 1012 on the IoT hub 110 may then decrypt the data packets using the IoT hub's private key. Similarly, the security subsystem 1002 on the IoT device 101 and/or the security subsystem 1012 on the IoT hub 110 may encrypt data packets sent to the IoT service 120 using the public key of the IoT service 120 (which may then be decrypted by the security subsystem 1013 on the IoT service 120 using the service's private key). Using symmetric keys, the device 101 and hub 110 may share a symmetric key while the hub and service 120 may share a different symmetric key.

While certain specific details are set forth above in the description above, it should be noted that the underlying principles of the invention may be implemented using various different encryption techniques. For example, while some embodiments discussed above use asymmetric public/private key pairs, an alternate embodiment may use symmetric keys securely exchanged between the various IoT devices 101-102, IoT hubs 110, and the IoT service 120. Moreover, in some embodiments, the data/command itself is not encrypted, but a key is used to generate a signature over the data/command (or other data structure). The recipient may then use its key to validate the signature.

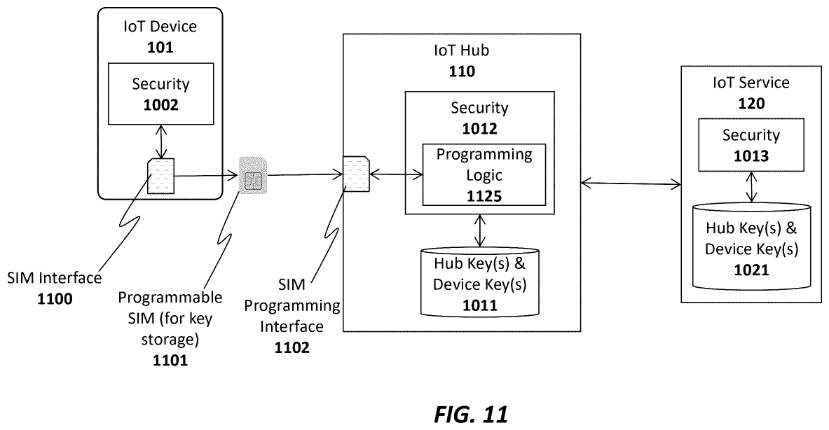

As illustrated in FIG. 11, in one embodiment, the secure key storage on each IoT device 101 is implemented using a programmable subscriber identity module (SIM) 1101. In this embodiment, the IoT device 101 may initially be provided to the end user with an un-programmed SIM card 1101 seated within a SIM interface 1100 on the IoT device 101. In order to program the SIM with a set of one or more encryption keys, the user takes the programmable SIM card 1101 out of the SIM interface 500 and inserts it into a SIM programming interface 1102 on the IoT hub 110. Programming logic 1125 on the IoT hub then securely programs the SIM card 1101 to register/pair the IoT device 101 with the IoT hub 110 and IoT service 120. In one embodiment, a public/private key pair may be randomly generated by the programming logic 1125 and the public key of the pair may then be stored in the IoT hub's secure storage device 411 while the private key may be stored within the programmable SIM 1101. In addition, the programming logic 525 may store the public keys of the IoT hub 110, the IoT service 120, and/or any other IoT devices 101 on the SIM card 1401 (to be used by the security subsystem 1302 on the IoT device 101 to encrypt outgoing data). Once the SIM 1101 is programmed, the new IoT device 101 may be provisioned with the IoT Service 120 using the SIM as a secure identifier (e.g., using existing techniques for registering a device using a SIM). Following provisioning, both the IoT hub 110 and the IoT service 120 will securely store a copy of the IoT device's public key to be used when encrypting communication with the IoT device 101.

The techniques described above with respect to FIG. 11 provide enormous flexibility when providing new IoT devices to end users. Rather than requiring a user to directly register each SIM with a particular service provider upon sale/purchase (as is currently done), the SIM may be programmed directly by the end user via the IoT hub 110 and the results of the programming may be securely communicated to the IoT service 120. Consequently, new IoT devices 101 may be sold to end users from online or local retailers and later securely provisioned with the IoT service 120.

While the registration and encryption techniques are described above within the specific context of a SIM (Subscriber Identity Module), the underlying principles of the invention are not limited to a “SIM” device. Rather, the underlying principles of the invention may be implemented using any type of device having secure storage for storing a set of encryption keys. Moreover, while the embodiments above include a removable SIM device, in one embodiment, the SIM device is not removable but the IoT device itself may be inserted within the programming interface 1102 of the IoT hub 110.

In one embodiment, rather than requiring the user to program the SIM (or other device), the SIM is pre-programmed into the IoT device 101, prior to distribution to the end user. In this embodiment, when the user sets up the IoT device 101, various techniques described herein may be used to securely exchange encryption keys between the IoT hub 110/IoT service 120 and the new IoT device 101.

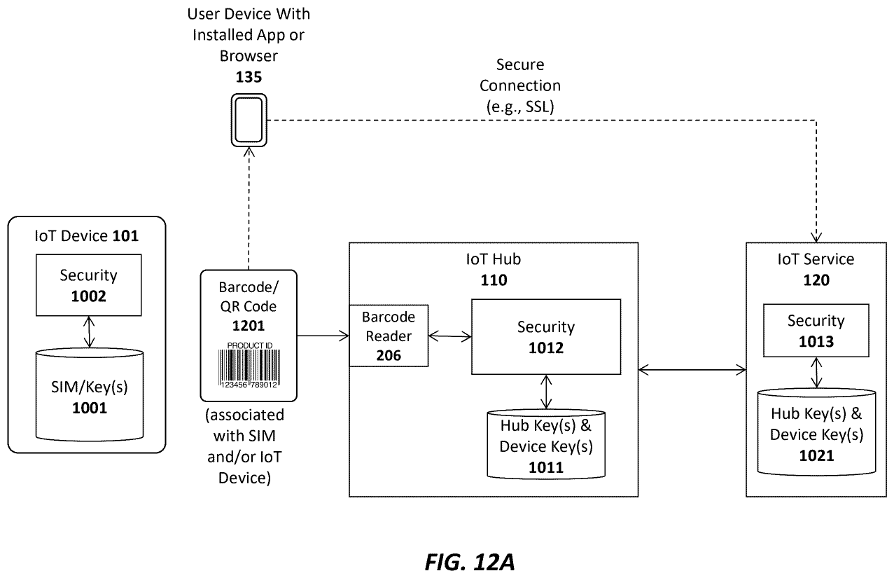

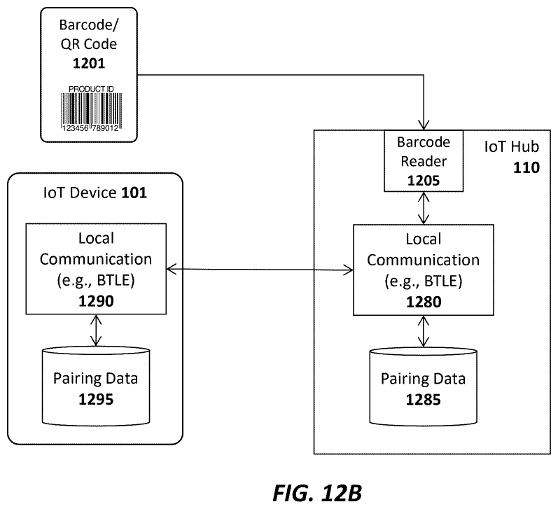

For example, as illustrated in FIG. 12A each IoT device 101 or SIM 401 may be packaged with a barcode or QR code 1501 uniquely identifying the IoT device 101 and/or SIM 1001. In one embodiment, the barcode or QR code 1201 comprises an encoded representation of the public key for the IoT device 101 or SIM 1001. Alternatively, the barcode or QR code 1201 may be used by the IoT hub 110 and/or IoT service 120 to identify or generate the public key (e.g., used as a pointer to the public key which is already stored in secure storage). The barcode or QR code 601 may be printed on a separate card (as shown in FIG. 12A) or may be printed directly on the IoT device itself. Regardless of where the barcode is printed, in one embodiment, the IoT hub 110 is equipped with a barcode reader 206 for reading the barcode and providing the resulting data to the security subsystem 1012 on the IoT hub 110 and/or the security subsystem 1013 on the IoT service 120. The security subsystem 1012 on the IoT hub 110 may then store the public key for the IoT device within its secure key storage 1011 and the security subsystem 1013 on the IoT service 120 may store the public key within its secure storage 1021 (to be used for subsequent encrypted communication).

In one embodiment, the data contained in the barcode or QR code 1201 may also be captured via a user device 135 (e.g., such as an iPhone or Android device) with an installed IoT app or browser-based applet designed by the IoT service provider. Once captured, the barcode data may be securely communicated to the IoT service 120 over a secure connection (e.g., such as a secure sockets layer (SSL) connection). The barcode data may also be provided from the client device 135 to the IoT hub 110 over a secure local connection (e.g., over a local WiFi or Bluetooth LE connection).

The security subsystem 1002 on the IoT device 101 and the security subsystem 1012 on the IoT hub 110 may be implemented using hardware, software, firmware or any combination thereof. For example, in one embodiment, the security subsystem 1002, 1012 is implemented within the chips used for establishing the local communication channel 130 between the IoT device 101 and the IoT hub 110 (e.g., the Bluetooth LE chip if the local channel 130 is Bluetooth LE). Regardless of the specific location of the security subsystem 1002, 1012, in one embodiment, the security subsystem 1002, 1012 is designed to establish a secure execution environment for executing certain types of program code. This may be implemented, for example, by using TrustZone technology (available on some ARM processors) and/or Trusted Execution Technology (designed by Intel). Of course, the underlying principles of the invention are not limited to any particular type of secure execution technology.

In one embodiment, the barcode or QR code 1501 may be used to pair each IoT device 101 with the IoT hub 110. For example, rather than using the standard wireless pairing process currently used to pair Bluetooth LE devices, a pairing code embedded within the barcode or QR code 1501 may be provided to the IoT hub 110 to pair the IoT hub with the corresponding IoT device.

FIG. 12B illustrates one embodiment in which the barcode reader 206 on the IoT hub 110 captures the barcode/QR code 1201 associated with the IoT device 101. As mentioned, the barcode/QR code 1201 may be printed directly on the IoT device 101 or may be printed on a separate card provided with the IoT device 101. In either case, the barcode reader 206 reads the pairing code from the barcode/QR code 1201 and provides the pairing code to the local communication module 1280. In one embodiment, the local communication module 1280 is a Bluetooth LE chip and associated software, although the underlying principles of the invention are not limited to any particular protocol standard. Once the pairing code is received, it is stored in a secure storage containing pairing data 1285 and the IoT device 101 and IoT hub 110 are automatically paired. Each time the IoT hub is paired with a new IoT device in this manner, the pairing data for that pairing is stored within the secure storage 685. In one embodiment, once the local communication module 1280 of the IoT hub 110 receives the pairing code, it may use the code as a key to encrypt communications over the local wireless channel with the IoT device 101.

Similarly, on the IoT device 101 side, the local communication module 1590 stores pairing data within a local secure storage device 1595 indicating the pairing with the IoT hub. The pairing data 1295 may include the pre-programmed pairing code identified in the barcode/QR code 1201. The pairing data 1295 may also include pairing data received from the local communication module 1280 on the IoT hub 110 required for establishing a secure local communication channel (e.g., an additional key to encrypt communication with the IoT hub 110).

Thus, the barcode/QR code 1201 may be used to perform local pairing in a far more secure manner than current wireless pairing protocols because the pairing code is not transmitted over the air. In addition, in one embodiment, the same barcode/QR code 1201 used for pairing may be used to identify encryption keys to build a secure connection from the IoT device 101 to the IoT hub 110 and from the IoT hub 110 to the IoT service 120.

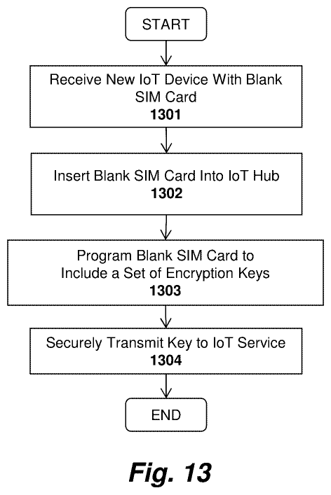

A method for programming a SIM card in accordance with one embodiment of the invention is illustrated in FIG. 13. The method may be implemented within the system architecture described above, but is not limited to any particular system architecture.

At 1301, a user receives a new IoT device with a blank SIM card and, at 1602, the user inserts the blank SIM card into an IoT hub. At 1303, the user programs the blank SIM card with a set of one or more encryption keys. For example, as mentioned above, in one embodiment, the IoT hub may randomly generate a public/private key pair and store the private key on the SIM card and the public key in its local secure storage. In addition, at 1304, at least the public key is transmitted to the IoT service so that it may be used to identify the IoT device and establish encrypted communication with the IoT device. As mentioned above, in one embodiment, a programmable device other than a “SIM” card may be used to perform the same functions as the SIM card in the method shown in FIG. 13.

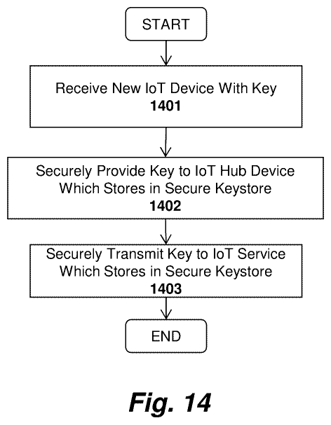

A method for integrating a new IoT device into a network is illustrated in FIG. 14. The method may be implemented within the system architecture described above, but is not limited to any particular system architecture.

At 1401, a user receives a new IoT device to which an encryption key has been pre-assigned. At 1402, the key is securely provided to the IoT hub. As mentioned above, in one embodiment, this involves reading a barcode associated with the IoT device to identify the public key of a public/private key pair assigned to the device. The barcode may be read directly by the IoT hub or captured via a mobile device via an app or bowser. In an alternate embodiment, a secure communication channel such as a Bluetooth LE channel, a near field communication (NFC) channel or a secure WiFi channel may be established between the IoT device and the IoT hub to exchange the key. Regardless of how the key is transmitted, once received, it is stored in the secure keystore of the IoT hub device. As mentioned above, various secure execution technologies may be used on the IoT hub to store and protect the key such as Secure Enclaves, Trusted Execution Technology (TXT), and/or Trustzone. In addition, at 803, the key is securely transmitted to the IoT service which stores the key in its own secure keystore. It may then use the key to encrypt communication with the IoT device. One again, the exchange may be implemented using a certificate/signed key. Within the hub 110 it is particularly important to prevent modification/addition/removal of the stored keys.

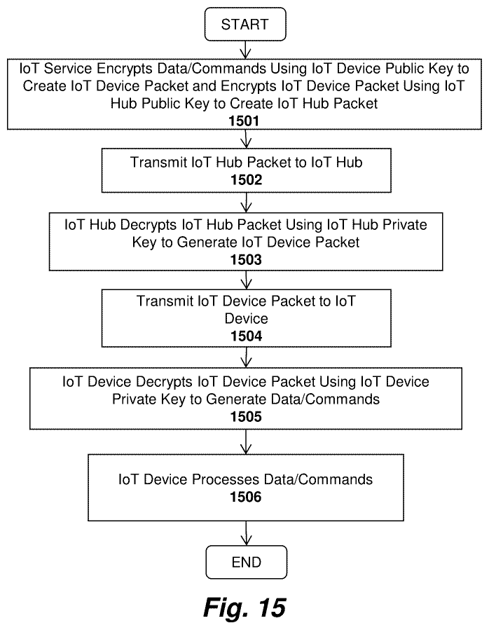

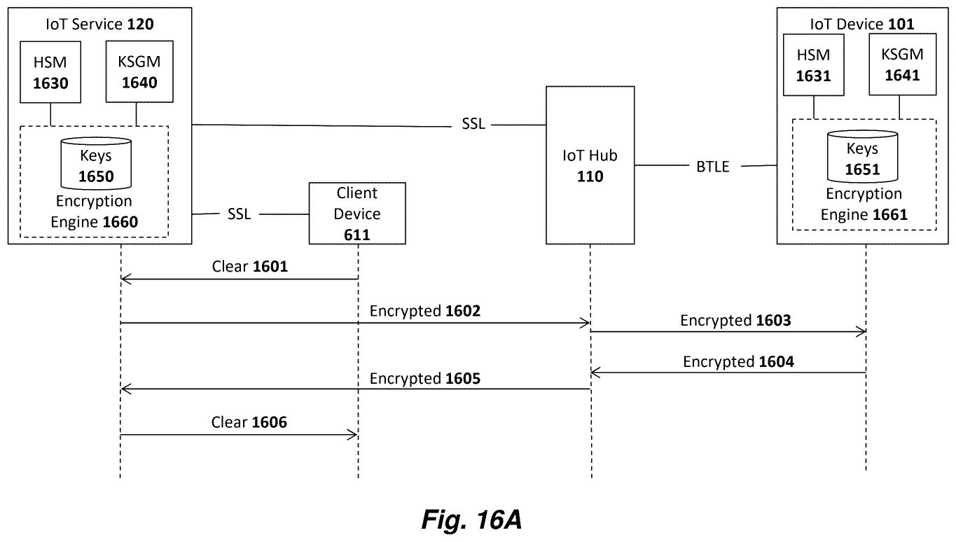

A method for securely communicating commands/data to an IoT device using public/private keys is illustrated in FIG. 15. The method may be implemented within the system architecture described above, but is not limited to any particular system architecture.

At 1501, the IoT service encrypts the data/commands using the IoT device public key to create an IoT device packet. It then encrypts the IoT device packet using IoT hub's public key to create the IoT hub packet (e.g., creating an IoT hub wrapper around the IoT device packet). At 1502, the IoT service transmits the IoT hub packet to the IoT hub. At 1503, the IoT hub decrypts the IoT hub packet using the IoT hub's private key to generate the IoT device packet. At 1504 it then transmits the IoT device packet to the IoT device which, at 1505, decrypts the IoT device packet using the IoT device private key to generate the data/commands. At 1506, the IoT device processes the data/commands.

In an embodiment which uses symmetric keys, a symmetric key exchange may be negotiated between each of the devices (e.g., each device and the hub and between the hub and the service). Once the key exchange is complete, each transmitting device encrypts and/or signs each transmission using the symmetric key before transmitting data to the receiving device.

### Apparatus and Method for Establishing Secure Communication Channels in an Internet of Things (IoT) System

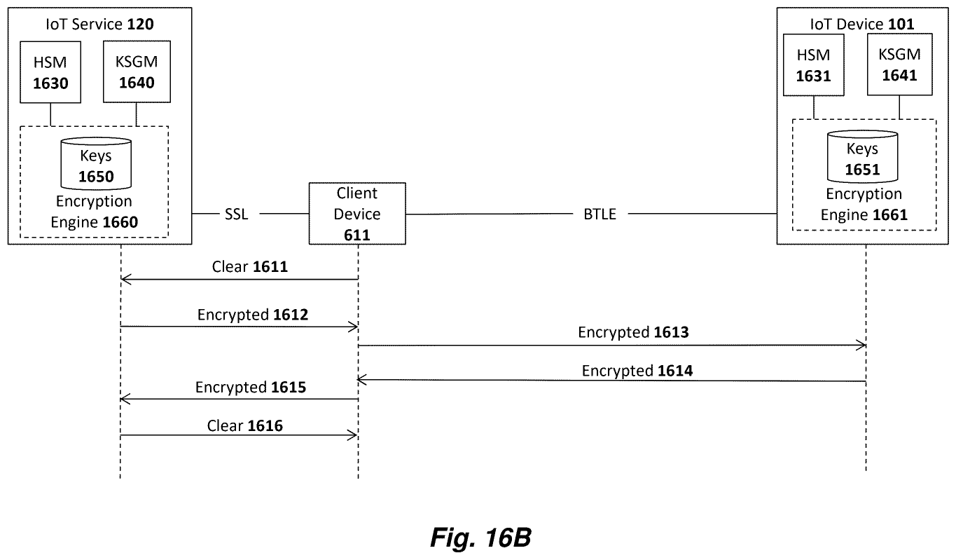

In one embodiment of the invention, encryption and decryption of data is performed between the IoT service 120 and each IoT device 101, regardless of the intermediate devices used to support the communication channel (e.g., such as the user's mobile device 611 and/or the IoT hub 110). One embodiment which communicates via an IoT hub 110 is illustrated in FIG. 16A and another embodiment which does not require an IoT hub is illustrated in FIG. 16B.

Turning first to FIG. 16A, the IoT service 120 includes an encryption engine 1660 which manages a set of “service session keys” 1650 and each IoT device 101 includes an encryption engine 1661 which manages a set of “device session keys” 1651 for encrypting/decrypting communication between the IoT device 101 and IoT service 120. The encryption engines may rely on different hardware modules when performing the security/encryption techniques described herein including a hardware security module 1630-1631 for (among other things) generating a session public/private key pair and preventing access to the private session key of the pair and a key stream generation module 1640-1641 for generating a key stream using a derived secret. In one embodiment, the service session keys 1650 and the device session keys 1651 comprise related public/private key pairs. For example, in one embodiment, the device session keys 1651 on the IoT device 101 include a public key of the IoT service 120 and a private key of the IoT device 101. As discussed in detail below, in one embodiment, to establish a secure communication session, the public/private session key pairs, 1650 and 1651, are used by each encryption engine, 1660 and 1661, respectively, to generate the same secret which is then used by the SKGMs 1640-1641 to generate a key stream to encrypt and decrypt communication between the IoT service 120 and the IoT device 101. Additional details associated with generation and use of the secret in accordance with one embodiment of the invention are provided below.

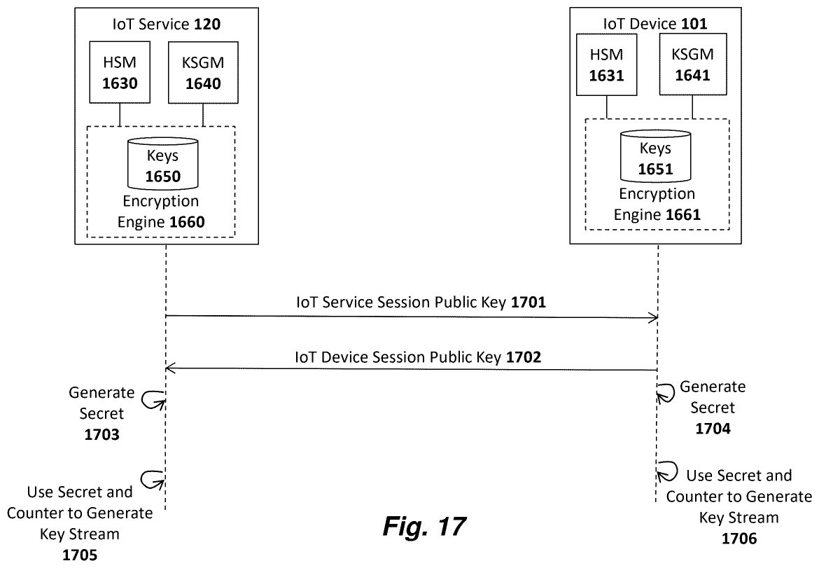

In FIG. 16A, once the secret has been generated using the keys 1650-1651, the client will always send messages to the IoT device 101 through the IoT service 120, as indicated by Clear transaction 1611. “Clear” as used herein is meant to indicate that the underlying message is not encrypted using the encryption techniques described herein. However, as illustrated, in one embodiment, a secure sockets layer (SSL) channel or other secure channel (e.g., an Internet Protocol Security (IPSEC) channel) is established between the client device 611 and IoT service 120 to protect the communication. The encryption engine 1660 on the IoT service 120 then encrypts the message using the generated secret and transmits the encrypted message to the IoT hub 110 at 1602. Rather than using the secret to encrypt the message directly, in one embodiment, the secret and a counter value are used to generate a key stream, which is used to encrypt each message packet. Details of this embodiment are described below with respect to FIG. 17.

As illustrated, an SSL connection or other secure channel may be established between the IoT service 120 and the IoT hub 110. The IoT hub 110 (which does not have the ability to decrypt the message in one embodiment) transmits the encrypted message to the IoT device at 1603 (e.g., over a Bluetooth Low Energy (BTLE) communication channel). The encryption engine 1661 on the IoT device 101 may then decrypt the message using the secret and process the message contents. In an embodiment which uses the secret to generate a key stream, the encryption engine 1661 may generate the key stream using the secret and a counter value and then use the key stream for decryption of the message packet.

The message itself may comprise any form of communication between the IoT service 120 and IoT device 101. For example, the message may comprise a command packet instructing the IoT device 101 to perform a particular function such as taking a measurement and reporting the result back to the client device 611 or may include configuration data to configure the operation of the IoT device 101.

If a response is required, the encryption engine 1661 on the IoT device 101 uses the secret or a derived key stream to encrypt the response and transmits the encrypted response to the IoT hub 110 at 1604, which forwards the response to the IoT service 120 at 1605. The encryption engine 1660 on the IoT service 120 then decrypts the response using the secret or a derived key stream and transmits the decrypted response to the client device 611 at 1606 (e.g., over the SSL or other secure communication channel).

FIG. 16B illustrates an embodiment which does not require an IoT hub. Rather, in this embodiment, communication between the IoT device 101 and IoT service 120 occurs through the client device 611 (e.g., as in the embodiments described above with respect to FIGS. 6-9B). In this embodiment, to transmit a message to the IoT device 101 the client device 611 transmits an unencrypted version of the message to the IoT service 120 at 1611. The encryption engine 1660 encrypts the message using the secret or the derived key stream and transmits the encrypted message back to the client device 611 at 1612. The client device 611 then forwards the encrypted message to the IoT device 101 at 1613, and the encryption engine 1661 decrypts the message using the secret or the derived key stream. The IoT device 101 may then process the message as described herein. If a response is required, the encryption engine 1661 encrypts the response using the secret and transmits the encrypted response to the client device 611 at 1614, which forwards the encrypted response to the IoT service 120 at 1615. The encryption engine 1660 then decrypts the response and transmits the decrypted response to the client device 611 at 1616.

FIG. 17 illustrates a key exchange and key stream generation which may initially be performed between the IoT service 120 and the IoT device 101. In one embodiment, this key exchange may be performed each time the IoT service 120 and IoT device 101 establish a new communication session. Alternatively, the key exchange may be performed and the exchanged session keys may be used for a specified period of time (e.g., a day, a week, etc). While no intermediate devices are shown in FIG. 17 for simplicity, communication may occur through the IoT hub 110 and/or the client device 611.

In one embodiment, the encryption engine 1660 of the IoT service 120 sends a command to the HSM 1630 (e.g., which may be such as a CloudHSM offered by Amazon®) to generate a session public/private key pair. The HSM 1630 may subsequently prevent access to the private session key of the pair. Similarly, the encryption engine on the IoT device 101 may transmit a command to the HSM 1631 (e.g., such as an Atecc508 HSM from Atmel Corporation®) which generates a session public/private key pair and prevents access to the session private key of the pair. Of course, the underlying principles of the invention are not limited to any specific type of encryption engine or manufacturer.

In one embodiment, the IoT service 120 transmits its session public key generated using the HSM 1630 to the IoT device 101 at 1701. The IoT device uses its HSM 1631 to generate its own session public/private key pair and, at 1702, transmits its public key of the pair to the IoT service 120. In one embodiment, the encryption engines 1660-1661 use an Elliptic curve Diffie-Hellman (ECDH) protocol, which is an anonymous key agreement that allows two parties with an elliptic curve public-private key pair, to establish a shared secret. In one embodiment, using these techniques, at 1703, the encryption engine 1660 of the IoT service 120 generates the secret using the IoT device session public key and its own session private key. Similarly, at 1704, the encryption engine 1661 of the IoT device 101 independently generates the same secret using the IoT service 120 session public key and its own session private key. More specifically, in one embodiment, the encryption engine 1660 on the IoT service 120 generates the secret according to the formula secret=IoT device session pub key*IoT service session private key, where ‘*’ means that the IoT device session public key is point-multiplied by the IoT service session private key. The encryption engine 1661 on the IoT device 101 generates the secret according to the formula secret=IoT service session pub key*IoT device session private key, where the IoT service session public key is point multiplied by the IoT device session private key. In the end, the IoT service 120 and IoT device 101 have both generated the same secret to be used to encrypt communication as described below. In one embodiment, the encryption engines 1660-1661 rely on a hardware module such as the KSGMs 1640-1641 respectively to perform the above operations for generating the secret.

Once the secret has been determined, it may be used by the encryption engines 1660 and 1661 to encrypt and decrypt data directly. Alternatively, in one embodiment, the encryption engines 1660-1661 send commands to the KSGMs 1640-1641 to generate a new key stream using the secret to encrypt/decrypt each data packet (i.e., a new key stream data structure is generated for each packet). In particular, one embodiment of the key stream generation module 1640-1641 implements a Galois/Counter Mode (GCM) in which a counter value is incremented for each data packet and is used in combination with the secret to generate the key stream. Thus, to transmit a data packet to the IoT service 120, the encryption engine 1661 of the IoT device 101 uses the secret and the current counter value to cause the KSGMs 1640-1641 to generate a new key stream and increment the counter value for generating the next key stream. The newly-generated key stream is then used to encrypt the data packet prior to transmission to the IoT service 120. In one embodiment, the key stream is XORed with the data to generate the encrypted data packet. In one embodiment, the IoT device 101 transmits the counter value with the encrypted data packet to the IoT service 120. The encryption engine 1660 on the IoT service then communicates with the KSGM 1640 which uses the received counter value and the secret to generate the key stream (which should be the same key stream because the same secret and counter value are used) and uses the generated key stream to decrypt the data packet.

In one embodiment, data packets transmitted from the IoT service 120 to the IoT device 101 are encrypted in the same manner. Specifically, a counter is incremented for each data packet and used along with the secret to generate a new key stream. The key stream is then used to encrypt the data (e.g., performing an XOR of the data and the key stream) and the encrypted data packet is transmitted with the counter value to the IoT device 101. The encryption engine 1661 on the IoT device 101 then communicates with the KSGM 1641 which uses the counter value and the secret to generate the same key stream which is used to decrypt the data packet. Thus, in this embodiment, the encryption engines 1660-1661 use their own counter values to generate a key stream to encrypt data and use the counter values received with the encrypted data packets to generate a key stream to decrypt the data.

In one embodiment, each encryption engine 1660-1661 keeps track of the last counter value it received from the other and includes sequencing logic to detect whether a counter value is received out of sequence or if the same counter value is received more than once. If a counter value is received out of sequence, or if the same counter value is received more than once, this may indicate that a replay attack is being attempted. In response, the encryption engines 1660-1661 may disconnect from the communication channel and/or may generate a security alert.

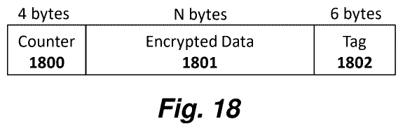

FIG. 18 illustrates an exemplary encrypted data packet employed in one embodiment of the invention comprising a 4-byte counter value 1800, a variable-sized encrypted data field 1801, and a 6-byte tag 1802. In one embodiment, the tag 1802 comprises a checksum value to validate the decrypted data (once it has been decrypted).

As mentioned, in one embodiment, the session public/private key pairs 1650-1651 exchanged between the IoT service 120 and IoT device 101 may be generated periodically and/or in response to the initiation of each new communication session.

One embodiment of the invention implements additional techniques for authenticating sessions between the IoT service 120 and IoT device 101. In particular, in one embodiment, hierarchy of public/private key pairs is used including a master key pair, a set of factory key pairs, and a set of IoT service key pairs, and a set of IoT device key pairs. In one embodiment, the master key pair comprises a root of trust for all of the other key pairs and is maintained in a single, highly secure location (e.g., under the control of the organization implementing the IoT systems described herein). The master private key may be used to generate signatures over (and thereby authenticate) various other key pairs such as the factory key pairs. The signatures may then be verified using the master public key. In one embodiment, each factory which manufactures IoT devices is assigned its own factory key pair which may then be used to authenticate IoT service keys and IoT device keys. For example, in one embodiment, a factory private key is used to generate a signature over IoT service public keys and IoT device public keys. These signature may then be verified using the corresponding factory public key. Note that these IoT service/device public keys are not the same as the “session” public/private keys described above with respect to FIGS. 16A-B. The session public/private keys described above are temporary (i.e., generated for a service/device session) while the IoT service/device key pairs are permanent (i.e., generated at the factory).

With the foregoing relationships between master keys, factory keys, service/device keys in mind, one embodiment of the invention performs the following operations to provide additional layers of authentication and security between the IoT service 120 and IoT device 101:

A. In one embodiment, the IoT service 120 initially generates a message containing the following:
1. The IoT service's unique ID:
   The IoT service's serial number;
   a Timestamp;
   The ID of the factory key used to sign this unique ID;
   a Class of the unique ID (i.e., a service);
   IoT service's public key
   The signature over the unique ID.
2. The Factory Certificate including:
   A timestamp.
   The ID of the master key used to sign the certificate
   The factory public key.
   The signature of the Factory Certificate
3. IoT service session public key (as described above with respect to FIGS. 16A-B)
4. IoT service session public key signature (e.g., signed with the IoT service's private key)

B. In one embodiment, the message is sent to the IoT device on the negotiation channel (described below). The IoT device parses the message and:
1. Verifies the signature of the factory certificate (only if present in the message payload)
2. Verifies the signature of the unique ID using the key identified by the unique ID
3. Verifies the IoT service session public key signature using the IoT service's public key from the unique ID
4. Saves the IoT service's public key as well as the IoT service's session public key
5. Generates the IoT device session key pair

C. The IoT device then generates a message containing the following:
1. IoT device's unique ID
   IoT device serial number
   Timestamp.
   ID of factory key used to sign this unique ID
   Class of unique ID (i.e., IoT device)·
   IoT device's public key
   Signature of unique ID
2. IoT device's session public key
3. Signature of (IoT device session public key+IoT service session public key) signed with IoT device's key

D. This message is sent back to the IoT service. The IoT service parses the message and:
1. Verifies the signature of the unique ID using the factory public key
2. Verifies the signature of the session public keys using the IoT device's public key
3. Saves the IoT device's session public key

E. The IoT service then generates a message containing a signature of (IoT device session public key+IoT service session public key) signed with the IoT service's key.

F. The IoT device parses the message and:
1. Verifies the signature of the session public keys using the IoT service's public key
2. Generates the key stream from the IoT device session private key and the IoT service's session public key
3. The IoT device then sends a “messaging available” message.

G. The IoT service then does the following:
1. Generates the key stream from the IoT service session private key and the IoT device's session public key
2. Creates a new message on the messaging channel which contains the following:
   Generates and stores a random 2 byte value
   Set attribute message with the boomerang attribute Id (discussed below) and the random value

H. The IoT device receives the message and:
1. Attempts to decrypt the message
2. Emits an Update with the same value on the indicated attribute Id

I. The IoT service recognizes the message payload contains a boomerang attribute update and:
1. Sets its paired state to true
2. Sends a pairing complete message on the negotiator channel

J. IoT device receives the message and sets his paired state to true

While the above techniques are described with respect to an “IoT service” and an “IoT device,” the underlying principles of the invention may be implemented to establish a secure communication channel between any two devices including user client devices, servers, and Internet services.

The above techniques are highly secure because the private keys are never shared over the air (in contrast to current Bluetooth pairing techniques in which a secret is transmitted from one party to the other). An attacker listening to the entire conversation will only have the public keys, which are insufficient to generate the shared secret. These techniques also prevent a man-in-the-middle attack by exchanging signed public keys. In addition, because GCM and separate counters are used on each device, any kind of “replay attack” (where a man in the middle captures the data and sends it again) is prevented. Some embodiments also prevent replay attacks by using asymmetrical counters.

Techniques for Exchanging Data and Commands without Formally Pairing Devices

GATT is an acronym for the Generic Attribute Profile, and it defines the way that two Bluetooth Low Energy (BTLE) devices transfer data back and forth. It makes use of a generic data protocol called the Attribute Protocol (ATT), which is used to store Services, Characteristics and related data in a simple lookup table using 16-bit Characteristic IDs for each entry in the table. Note that while the “characteristics” are sometimes referred to as “attributes.”

On Bluetooth devices, the most commonly used characteristic is the devices “name” (having characteristic ID 10752 (0x2A00)). For example, a Bluetooth device may identify other Bluetooth devices within its vicinity by reading the “Name” characteristic published by those other Bluetooth devices using GATT. Thus, Bluetooth device have the inherent ability to exchange data without formally pairing/bonding the devices (note that “paring” and “bonding” are sometimes used interchangeably; the remainder of this discussion will use the term “pairing”).

One embodiment of the invention takes advantage of this capability to communicate with BTLE-enabled IoT devices without formally pairing with these devices. Pairing with each individual IoT device would extremely inefficient because of the amount of time required to pair with each device and because only one paired connection may be established at a time.

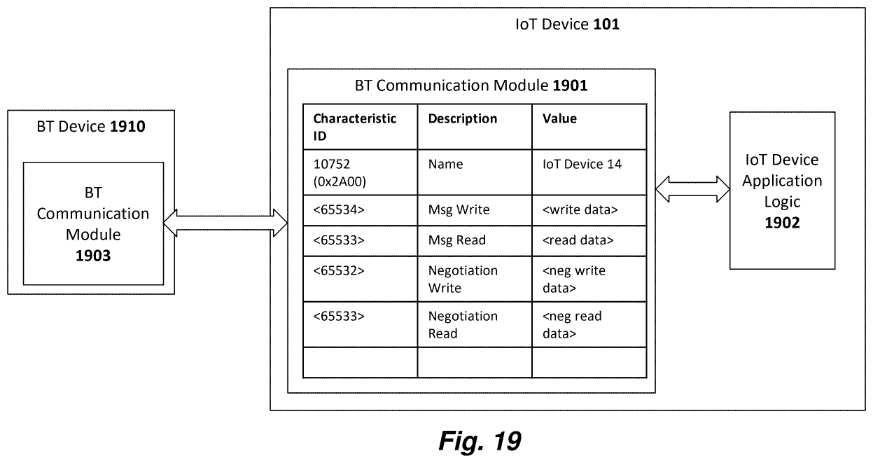

FIG. 19 illustrates one particular embodiment in which a Bluetooth (BT) device 1910 establishes a network socket abstraction with a BT communication module 1901 of an IoT device 101 without formally establishing a paired BT connection. The BT device 1910 may be included in an IoT hub 110 and/or a client device 611 such as shown in FIG. 16A. As illustrated, the BT communication module 1901 maintains a data structure containing a list of characteristic IDs, names associated with those characteristic IDs and values for those characteristic IDs. The value for each characteristic may be stored within a 20-byte buffer identified by the characteristic ID in accordance with the current BT standard. However, the underlying principles of the invention are not limited to any particular buffer size.

In the example in FIG. 19, the “Name” characteristic is a BT-defined characteristic which is assigned a specific value of “IoT Device 14.” One embodiment of the invention specifies a first set of additional characteristics to be used for negotiating a secure communication channel with the BT device 1910 and a second set of additional characteristics to be used for encrypted communication with the BT device 1910. In particular, a “negotiation write” characteristic, identified by characteristic ID <65532> in the illustrated example, may be used to transmit outgoing negotiation messages and the “negotiation read” characteristic, identified by characteristic ID <65533> may be used to receive incoming negotiation messages. The “negotiation messages” may include messages used by the BT device 1910 and the BT communication module 1901 to establish a secure communication channel as described herein. By way of example, in FIG. 17, the IoT device 101 may receive the IoT service session public key 1701 via the “negotiation read” characteristic <65533>. The key 1701 may be transmitted from the IoT service 120 to a BTLE-enabled IoT hub 110 or client device 611 which may then use GATT to write the key 1701 to the negotiation read value buffer identified by characteristic ID <65533>. IoT device application logic 1902 may then read the key 1701 from the value buffer identified by characteristic ID <65533> and process it as described above (e.g., using it to generate a secret and using the secret to generate a key stream, etc).

If the key 1701 is greater than 20 bytes (the maximum buffer size in some current implementations), then it may be written in 20-byte portions. For example, the first 20 bytes may be written by the BT communication module 1903 to characteristic ID <65533> and read by the IoT device application logic 1902, which may then write an acknowledgement message to the negotiation write value buffer identified by characteristic ID <65532>. Using GATT, the BT communication module 1903 may read this acknowledgement from characteristic ID <65532> and responsively write the next 20 bytes of the key 1701 to the negotiation read value buffer identified by characteristic ID <65533>. In this manner, a network socket abstraction defined by characteristic IDs <65532> and <65533> is established for exchanging negotiation messages used to establish a secure communication channel.

In one embodiment, once the secure communication channel is established, a second network socket abstraction is established using characteristic ID <65534> (for transmitting encrypted data packets from IoT device 101) and characteristic ID <65533> (for receiving encrypted data packets by IoT device). That is, when BT communication module 1903 has an encrypted data packet to transmit (e.g., such as encrypted message 1603 in FIG. 16A), it starts writing the encrypted data packet, 20 bytes at a time, using the message read value buffer identified by characteristic ID <65533>. The IoT device application logic 1902 will then read the encrypted data packet, 20 bytes at a time, from the read value buffer, sending acknowledgement messages to the BT communication module 1903 as needed via the write value buffer identified by characteristic ID <65532>.

In one embodiment, the commands of GET, SET, and UPDATE described below are used to exchange data and commands between the two BT communication modules 1901 and 1903. For example, the BT communication module 1903 may send a packet identifying characteristic ID <65533> and containing the SET command to write into the value field/buffer identified by characteristic ID <65533> which may then be read by the IoT device application logic 1902. To retrieve data from the IoT device 101, the BT communication module 1903 may transmit a GET command directed to the value field/buffer identified by characteristic ID <65534>. In response to the GET command, the BT communication module 1901 may transmit an UPDATE packet to the BT communication module 1903 containing the data from the value field/buffer identified by characteristic ID <65534>. In addition, UPDATE packets may be transmitted automatically, in response to changes in a particular attribute on the IoT device 101. For example, if the IoT device is associated with a lighting system and the user turns on the lights, then an UPDATE packet may be sent to reflect the change to the on/off attribute associated with the lighting application.

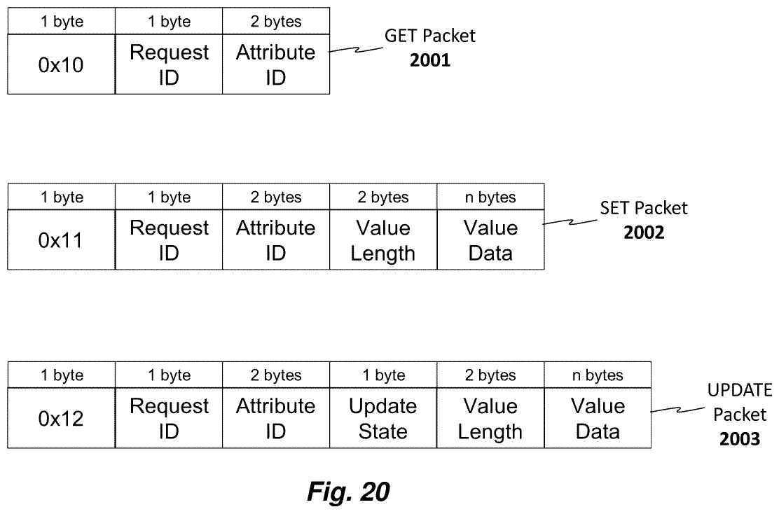

FIG. 20 illustrates exemplary packet formats used for GET, SET, and UPDATE in accordance with one embodiment of the invention. In one embodiment, these packets are transmitted over the message write <65534> and message read <65533> channels following negotiation. In the GET packet 2001, a first 1-byte field includes a value (0X10) which identifies the packet as a GET packet. A second 1-byte field includes a request ID, which uniquely identifies the current GET command (i.e., identifies the current transaction with which the GET command is associated). For example, each instance of a GET command transmitted from a service or device may be assigned a different request ID. This may be done, for example, by incrementing a counter and using the counter value as the request ID. However, the underlying principles of the invention are not limited to any particular manner for setting the request ID.

A 2-byte attribute ID identifies the application-specific attribute to which the packet is directed. For example, if the GET command is being sent to IoT device 101 illustrated in FIG. 19, the attribute ID may be used to identify the particular application-specific value being requested. Returning to the above example, the GET command may be directed to an application-specific attribute ID such as power status of a lighting system, which comprises a value identifying whether the lights are powered on or off (e.g., 1=on, 0=off). If the IoT device 101 is a security apparatus associated with a door, then the value field may identify the current status of the door (e.g., 1=opened, 0=closed). In response to the GET command, a response may be transmitting containing the current value identified by the attribute ID.

The SET packet 2002 and UPDATE packet 2003 illustrated in FIG. 20 also include a first 1-byte field identifying the type of packet (i.e., SET and UPDATE), a second 1-byte field containing a request ID, and a 2-byte attribute ID field identifying an application-defined attribute. In addition, the SET packet includes a 2-byte length value identifying the length of data contained in an n-byte value data field. The value data field may include a command to be executed on the IoT device and/or configuration data to configure the operation of the IoT device in some manner (e.g., to set a desired parameter, to power down the IoT device, etc). For example, if the IoT device 101 controls the speed of a fan, the value field may reflect the current fan speed.

The UPDATE packet 2003 may be transmitted to provide an update of the results of the SET command. The UPDATE packet 2003 includes a 2-byte length value field to identify the length of the n-byte value data field which may include data related to the results of the SET command. In addition, a 1-byte update state field may identify the current state of the variable being updated. For example, if the SET command attempted to turn off a light controlled by the IoT device, the update state field may indicate whether the light was successfully turned off.

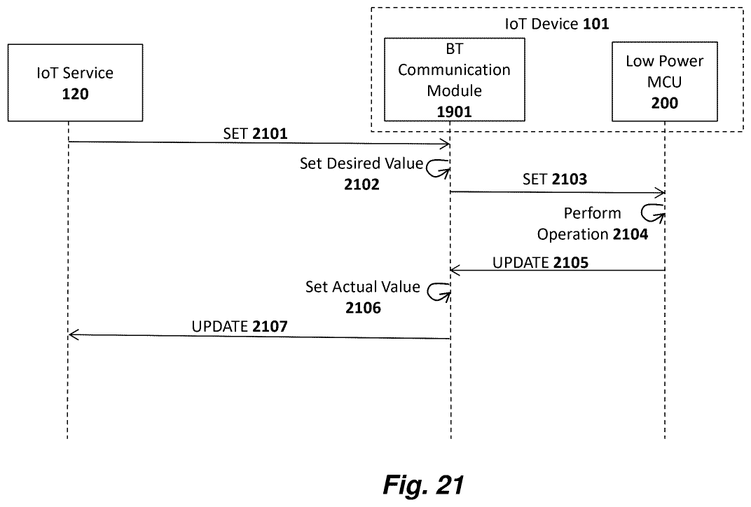

FIG. 21 illustrates an exemplary sequence of transactions between the IoT service 120 and an IoT device 101 involving the SET and UPDATE commands. Intermediary devices such as the IoT hub and the user's mobile device are not shown to avoid obscuring the underlying principles of the invention. At 2101, the SET command 2101 is transmitted form the IoT service to the IoT device 101 and received by the BT communication module 1901 which responsively updates the GATT value buffer identified by the characteristic ID at 2102. The SET command is read from the value buffer by the low power microcontroller (MCU) 200 at 2103 (or by program code being executed on the low power MCU such as IoT device application logic 1902 shown in FIG. 19). At 2104, the MCU 200 or program code performs an operation in response to the SET command. For example, the SET command may include an attribute ID specifying a new configuration parameter such as a new temperature or may include a state value such as on/off (to cause the IoT device to enter into an “on” or a low power state). Thus, at 2104, the new value is set in the IoT device and an UPDATE command is returned at 2105 and the actual value is updated in a GATT value field at 2106. In some cases, the actual value will be equal to the desired value. In other cases, the updated value may be different (i.e., because it may take time for the IoT device 101 to update certain types of values). Finally, at 2107, the UPDATE command is transmitted back to the IoT service 120 containing the actual value from the GATT value field.

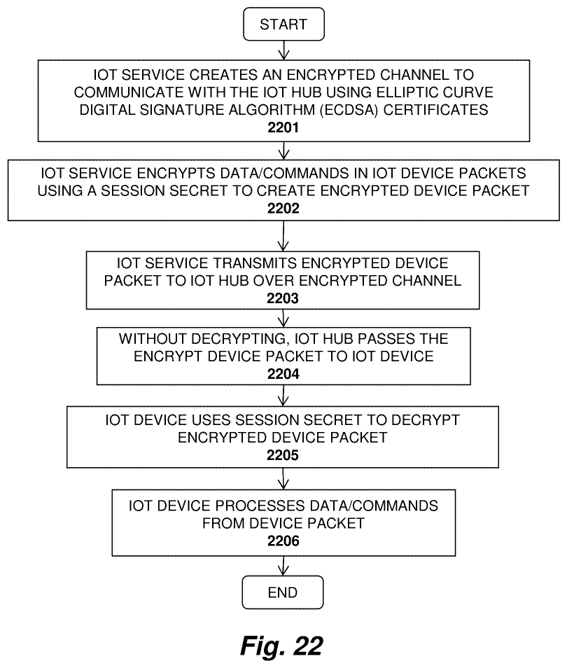

FIG. 22 illustrates a method for implementing a secure communication channel between an IoT service and an IoT device in accordance with one embodiment of the invention. The method may be implemented within the context of the network architectures described above but is not limited to any specific architecture.

At 2201, the IoT service creates an encrypted channel to communicate with the IoT hub using elliptic curve digital signature algorithm (ECDSA) certificates. At 2202, the IoT service encrypts data/commands in IoT device packets using the a session secret to create an encrypted device packet. As mentioned above, the session secret may be independently generated by the IoT device and the IoT service. At 2203, the IoT service transmits the encrypted device packet to the IoT hub over the encrypted channel. At 2204, without decrypting, the IoT hub passes the encrypted device packet to the IoT device. At 2205, the IoT device uses the session secret to decrypt the encrypted device packet. As mentioned, in one embodiment this may be accomplished by using the secret and a counter value (provided with the encrypted device packet) to generate a key stream and then using the key stream to decrypt the packet. At 2206, the IoT device then extracts and processes the data and/or commands contained within the device packet.

Thus, using the above techniques, bi-directional, secure network socket abstractions may be established between two BT-enabled devices without formally pairing the BT devices using standard pairing techniques. While these techniques are described above with respect to an IoT device 101 communicating with an IoT service 120, the underlying principles of the invention may be implemented to negotiate and establish a secure communication channel between any two BT-enabled devices.

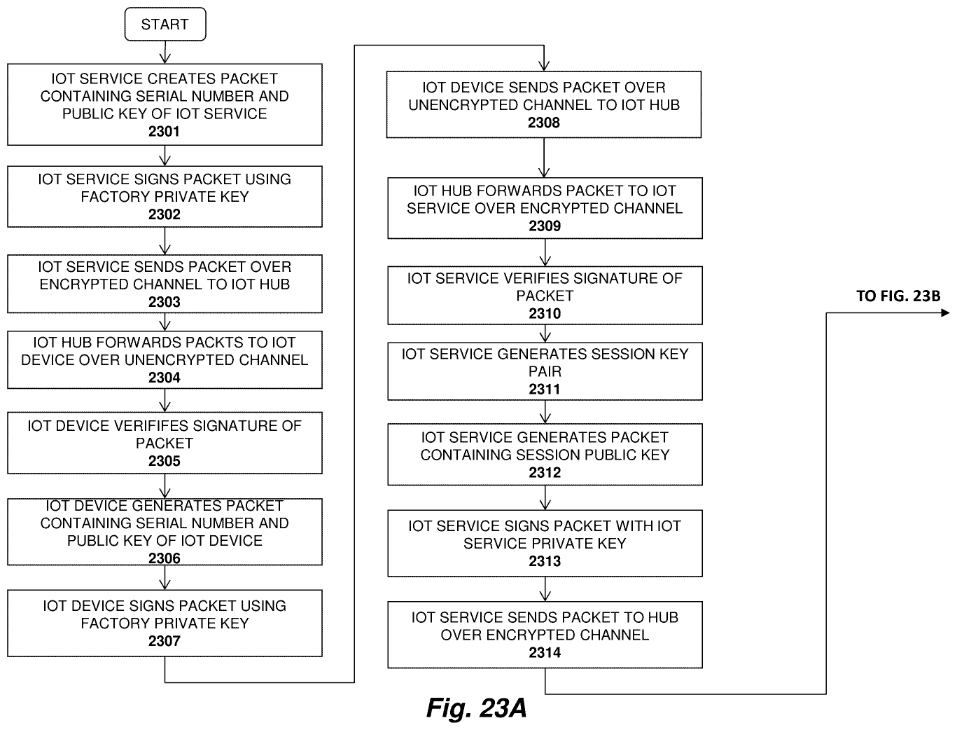

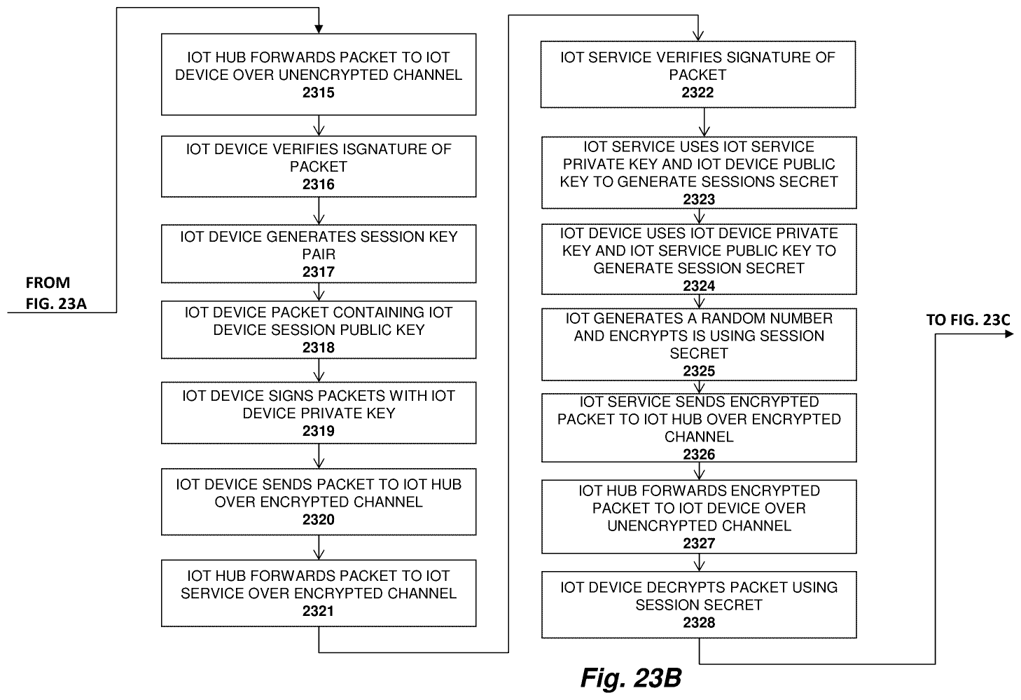

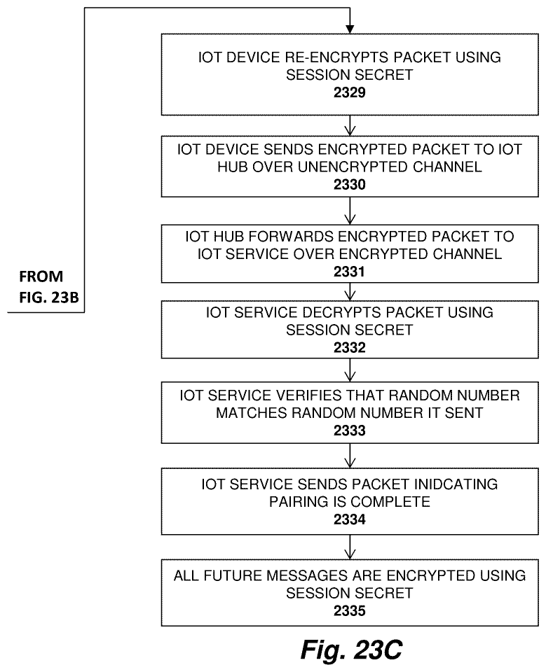

FIGS. 23A-C illustrate a detailed method for pairing devices in accordance with one embodiment of the invention. The method may be implemented within the context of the system architectures described above, but is not limited to any specific system architectures.

At 2301, the IoT Service creates a packet containing serial number and public key of the IoT Service. At 2302, the IoT Service signs the packet using the factory private key. At 2303, the IoT Service sends the packet over an encrypted channel to the IoT hub and at 2304 the IoT hub forwards the packet to IoT device over an unencrypted channel. At 2305, the IoT device verifies the signature of packet and, at 2306, the IoT device generates a packet containing the serial number and public key of the IoT Device. At 2307, the IoT device signs the packet using the factory private key and at 2308, the IoT device sends the packet over the unencrypted channel to the IoT hub.

At 2309, the IoT hub forwards the packet to the IoT service over an encrypted channel and at 2310, the IoT Service verifies the signature of the packet. At 2311, the IoT Service generates a session key pair, and at 2312 the IoT Service generates a packet containing the session public key. The IoT Service then signs the packet with IoT Service private key at 2313 and, at 2314, the IoT Service sends the packet to the IoT hub over the encrypted channel.

Turning to FIG. 23B, the IoT hub forwards the packet to the IoT device over the unencrypted channel at 2315 and, at 2316, the IoT device verifies the signature of packet. At 2317 the IoT device generates session key pair (e.g., using the techniques described above), and, at 2318, an IoT device packet is generated containing the IoT device session public key. At 2319, the IoT device signs the IoT device packet with IoT device private key. At 2320, the IoT device sends the packet to the IoT hub over the unencrypted channel and, at 2321, the IoT hub forwards the packet to the IoT service over an encrypted channel.

At 2322, the IoT service verifies the signature of the packet (e.g., using the IoT device public key) and, at 2323, the IoT service uses the IoT service private key and the IoT device public key to generate the session secret (as described in detail above). At 2324, the IoT device uses the IoT device private key and IoT service public key to generate the session secret (again, as described above) and, at 2325, the IoT device generates a random number and encrypts it using the session secret. At 2326, the IoT service sends the encrypted packet to IoT hub over the encrypted channel. At 2327, the IoT hub forwards the encrypted packet to the IoT device over the unencrypted channel. At 2328, the IoT device decrypts the packet using the session secret.

Turning to FIG. 23C, the IoT device re-encrypts the packet using the session secret at 2329 and, at 2330, the IoT device sends the encrypted packet to the IoT hub over the unencrypted channel. At 2331, the IoT hub forwards the encrypted packet to the IoT service over the encrypted channel. The IoT service decrypts the packet using the session secret at 2332. At 2333 the IoT service verifies that the random number matches the random number it sent. The IoT service then sends a packet indicating that pairing is complete at 2334 and all subsequent messages are encrypted using the session secret at 2335.

### Apparatus and Method for Cryptographically Securing Unpowered or Non-Electronic IoT Devices

Attestation of providence and of single use is necessary for a large class of products including, by way of example, and not limitation, home medical testing kits and digital tax stamps for controlled substances. However, because many of these products are non-electronic, vigorous attestation can be challenging. Embodiments of the invention include techniques for securely attesting such products using key-based signatures and a defined chain of trust.

The embodiments described above provide cryptographic protections for IoT devices using a Public Key Infrastructure which relies on a chain of trust. In some of these embodiments IoT devices can transmit data to communicate their identity as well as a device certificate that is signed by a which, in turn, was signed by any number of devices in a chain, up to a common Root key. For example, in FIGS. 23A-C, a factory private key is used to cryptographically secure communication between an IoT device and the IoT service. In particular, at 2302, the IoT service signs an outgoing packet using the factory private key and at 2307, the IoT device signs an outgoing packet using the factory private key. These operations form a portion of a larger sequence of transactions for generating a session secret to encrypt communication between the IoT device and the IoT service. Thus, this sequence of operations rely on an operational, connected IoT device.

In these embodiments, the certificate chain can be traversed to validate that the device is authentic. In addition, these embodiments rely on a well-defined factory provisioning process which produces a record of devices that can be compared against when a device is interacted with.

Embodiments of the invention perform a modified series of transactions to cryptographically secure inactive or non-electronic devices or products (sometimes referred to as “passive” products), while still relying on the chain of trust and aspects of the cryptographic framework described above. In this use case, only the authenticity of the passive product needs to be verified because the dataflow is only from the passive product to the IoT service.

A sufficient amount of cryptographic information is encoded in a machine-readable optical code (e.g., QR code or barcode) on the passive product for the mobile app and/or the IoT service to identify and verify the authenticity of the product. Because factories are not perfect at maintaining and delivering factory logs, these embodiments can do so even in the event of the occasional missed product to ensure an acceptable customer experience, while still ensuring that the factory did, in fact, produce the passive product device in question.

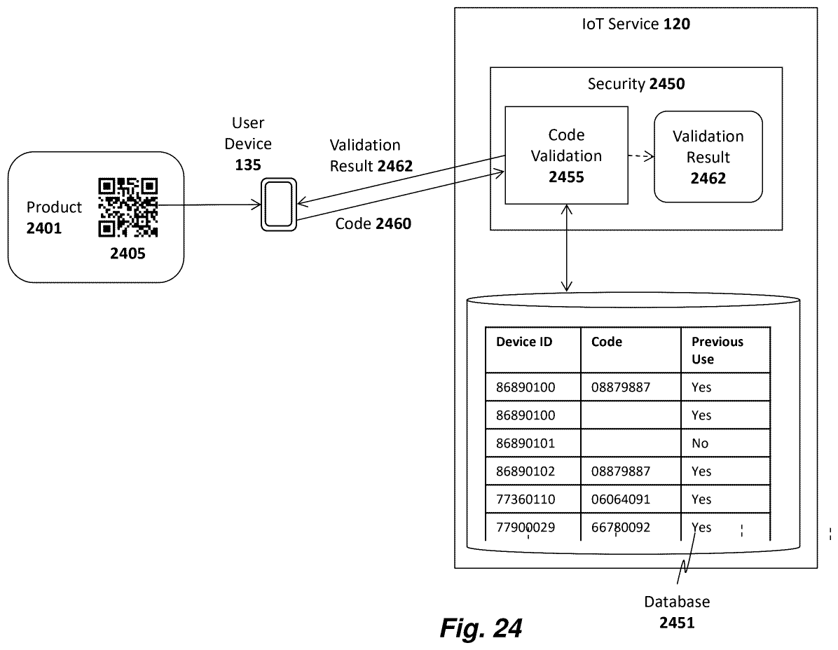

Referring to FIG. 24, one embodiment of the invention operates in accordance with the following sequence of operations to authenticate a passive product 2401. By way of example, and not limitation, the passive product 2401 may be medical test kit used to test for an infectious disease. As such, the test kit must be validated to confirm that it has not been previously used.

From the mobile app on the user's device 135 (which may be the same as the IoT device app described herein), the machine-readable optical label 2405 (e.g., a 2D barcode) is scanned and the resulting code 2460 is transmitted to a security module 2450 on the IoT service 120. As mentioned, the client device 135 may initially establish a secure communication channel with the IoT service 120 (e.g., an SSL channel).

The security module 2450 attempts to verify the code 2460 extracted from the optical label 2405. A code validation module 2455 may initially query the product database 2451 to determine if the code 2460 has previously been used. In one embodiment, as soon as a particular product has been used, the database 2451 is updated accordingly—and the same product can not be used more than once. Thus, if the product has been previously used, the validation result 2462 transmitted to the user device 135 informs the user of the error and prevents recording of any test result.

If the code 2460 passes the “prior use” check, then a digital signature check is performed, to confirm that a signature included with the code 2460 is valid. For example, the code validation module 2455 may regenerate the signature over the product ID and other metadata initially used to generate the signature, to determine whether the signature is valid. If the signature check fails, then the validation result 2462 will indicate a failure on a digital signature check; the user will be informed that the test is invalid and should not be used.

If, however, the code 2460 passes both the prior use check and the signature validation, then the security module 2450 will mark it as used in the database 2451 so that it cannot be reused. The validation result 2462 will then indicate to the user that the test is valid and can be used.

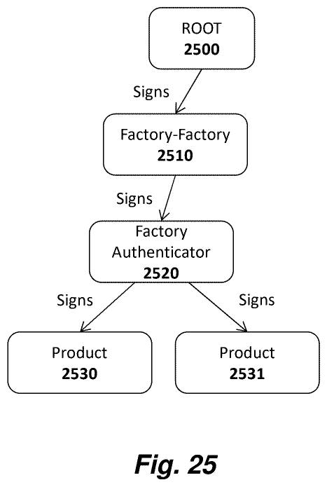

Additional details associated with the code 2460, including the signature, encoded in the machine-readable optical code are provided below. FIG. 25 illustrates the chain of trust used to generate signatures on various forms of products 2530-2531, including non-electronic, “passive” products described herein. A root of trust 2500 includes a secret key used to generate a signature on a factory-factory authentication device key 2510, which is used as the cryptographic root of trust at a particular factory. The factory-factory authenticator 2510 is sometimes referred to herein as the “level 1” factory authenticator. The factory-factory device key 2510 may be used to generate signatures over one or more keys of factory authenticator devices 2520, or “level 2” factory authenticators, which are used on the floor of the factory to generate signatures on the various products 2530-2531.

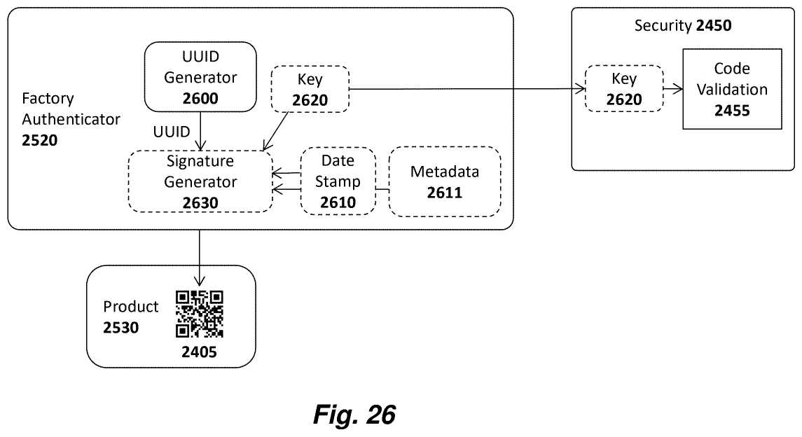

FIG. 26 illustrates additional details of the operations performed by the factory authenticator 2520 to generate the optical label 2405 for a product 2530, allowing the product 2530 to be cryptographically validated. In various embodiments, the factory authenticator 2520 may be a data processing device with a CPU (or other processor) and memory for executing the authentication operations described herein. The factory authenticator may also include dedicated hardware for performing these operations and for securely storing its assigned keys (e.g., a HSM device). A user interface may be provided to allow a factory worker to control the operations described herein.

In the illustrated embodiment, the universally unique identifier (UUID) generator 2600 generates a large random number to be used as a unique ID. The UUID is sufficiently large to ensure that it is statistically highly unlikely that there will ever be two devices assigned the same UUID (e.g., 128 bits).

In one embodiment, a signature generator 2630 of the factory authenticator 2520 uses the factory authenticator key 2620 to generate a signature over the UUID, a date stamp 2610, and other specified metadata 2611 associated with the factory authenticator 2520. For example, the metadata 2611 may include a unique identification code and/or hardware/software version associated with the authenticator 2520. Various other forms of metadata may be combined with the UUID to generate the signature. Once generated, the signature may be encoded in the optical label 2405 along with the UUID. In one embodiment, the UUID, metadata, and signature are encoded in a 40×40 QR code; however, the underlying principles of the invention are not limited to this implementation.

As illustrated, the key 2620 is provided to the security module 2450 so that the code validation logic 2455 can subsequently validate the signature extracted from the optical label 2405 as described with respect to FIG. 24. For example, the security module 2450 may regenerate the signature over the UUID and metadata using the key 2620 and validate the product 2530 if the signatures match.

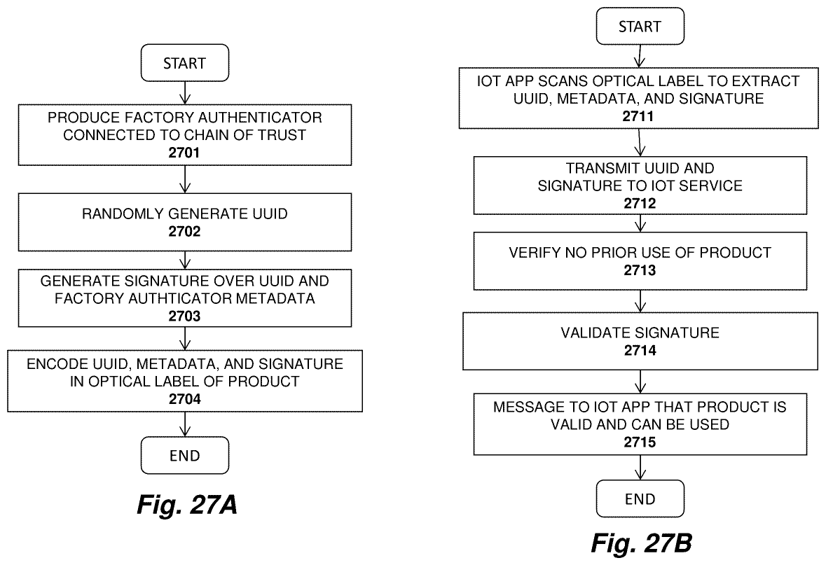

A method for cryptographically securing a product is illustrated in FIG. 27A and a method for validating the cryptographically secured product is illustrated in FIG. 27B. These methods may be executed in the context of the system architectures described above, but are not limited to any particular system architecture.

At 2701, a factory authenticator is produced from an authentication device further up towards the root of trust (e.g., the factory-factory authenticator described above). At 2702, a UUID is randomly generated and, at 2703, a signature is generated over the UUID and factory authenticator metadata (e.g., version identifiers, date stamp, etc). At 2704, the UUID, metadata, and signature are encoded in an optical label of the product.

At 2711 of FIG. 27B, the IoT app causes the mobile device to capture an image of the optical label to extract the UUID, metadata, and signature. At 2712, the UUID, metadata and signature are transmitted to the IoT service and, at 2713, the IoT service initially verifies that there has been no prior use of the product. This step is particularly important for at home medical test kits, which can only be used once.

Once it has been determined that the test kit has not been previously used, at 2714, the IoT service validates the signature. For example, it may regenerate the signature with the same key and over the same data (e.g., the UUID and metadata) as used to generate the encoded signature. If the signatures match, then at 2715, a message is sent to the IoT app that the product is valid and can be used.

The above techniques can be used to track and cryptographically validate any type of products, but may be particularly beneficial for certain types of products which require a heightened level of security, such as at-home medical testing kits, and digital tax stamps for controlled substances (e.g., alcohol, cannabis, etc). However, virtually any type of product tracking system can benefit from the authentication techniques described herein.

### Apparatus and Method for Efficient and Secure Pairing and Communication

One embodiment of the invention includes mechanisms for securely pairing a Bluetooth peripheral with a computer or mobile device. In particular, a QR code generated by a factory authenticator, as described above, is used to uniquely identify a peripheral device to securely expedite the pairing process.

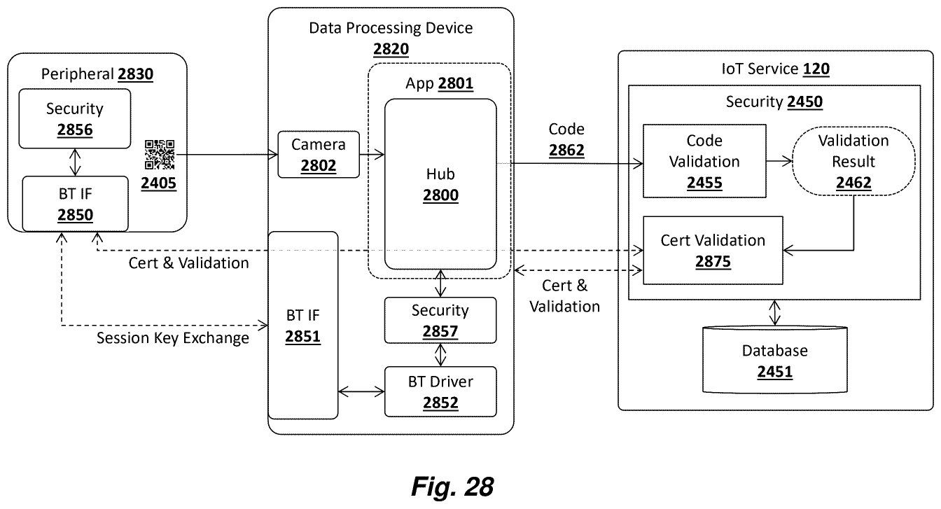

Referring to FIG. 28, in one embodiment, a QR code 2405 is captured by a camera 2802 of a data processing device 2820 to pair the peripheral device 2830 with the data processing device 2820. In this embodiment, the data processing device executes an app 2801 associated with the IoT service 120 which includes a hub 2800 to communicatively couple the peripheral 2830 to the IoT service 120. The IoT service 120 acts as an intermediary between the peripheral 2830 and the data processing device 2820 during the pairing process. In one implementation, the IoT service 120 includes a security subsystem 2450 which verifies the identity of the peripheral 2830 based on the QR code 2405 and validates the certificates generated by the peripheral device 2830 and the data processing device 2820. A session key is then exchanged between the peripheral device 2830 and data processing device 2820 to establish a secure Bluetooth channel.

In operation, the Bluetooth interface 2850 of the peripheral 2830 establishes a link with the Bluetooth interface 2851 of the data processing device 2820, allowing the peripheral 2830 to securely connect with the IoT service 120 via the hub 2800. The code 2862 captured from the QR code 2405 with the camera 2802, is provided by the hub 2800 to the IoT service 120. Code validation logic 2455 validates the code 2862 using identification data related to the peripheral 2830 stored in the database 2451 (e.g., a Device ID, UUID, factory-generated keys, etc). As described above, the code 2862 may include a signature generated over a unique peripheral ID which can be verified by the code validation logic 2455.

If the validation result 2462 indicates that the code 2862 is valid, then the security subsystem 2856 on the peripheral 2830 and security subsystem 2857 on the data processing device 2820 generate separate public/private key pairs and corresponding certificates (e.g., using a combination of the public key and device-specific data). For example, the security subsystem 2856 on the peripheral 2830 may combine the peripheral public key with the peripheral's MAC address and/or Device ID (or any other unique identifier) to generate the peripheral certificate and the security subsystem 2857 on the data processing device 2820 may combine the data processing device's public key with the device's MAC address and/or UUID to generate the data processing device certificate. Of course, various other information may be included in the certificates while still complying with the underlying principles of the invention.

The certificates are sent to the IoT service 120 where certificate validation logic 2875 validates and generates a signature over the certificates (e.g., signing the certificates with the IoT service private key) and returns the signed certificates to the peripheral device 2830 and data processing device 2820. Once validated, the security subsystem 2856 of the peripheral and security subsystem 2857 of the data processing device 2820 use the key pairs to securely generate and share a secret, which is used to produce the session key for secure Bluetooth communication. For example, the peripheral security logic 2856 may generate the session key using its private key and the data processing device public key while the data processing device security logic 2857 may generate the session key using its private key and the peripheral public key.

In one implementation, the session key is then used by the Bluetooth driver 2852 to encrypt/decrypt communication. The Bluetooth driver 2852 may be a human interface device (HID) driver which provides for secure HID communication and translates to the normal HID driver format used for a particular operating system (e.g., Windows 11, MacOS, Linux, etc).

Thus, by using the IoT service 120 as a trusted intermediary, the peripheral device 2830 can be efficiently and securely paired with the data processing device 2820 simply by capturing the QR code 2405 provided on the peripheral 2830. This is in contrast to current Bluetooth pairing implementations in which at least some unencrypted information is transmitted in the clear and which is a burdensome process for the end user.

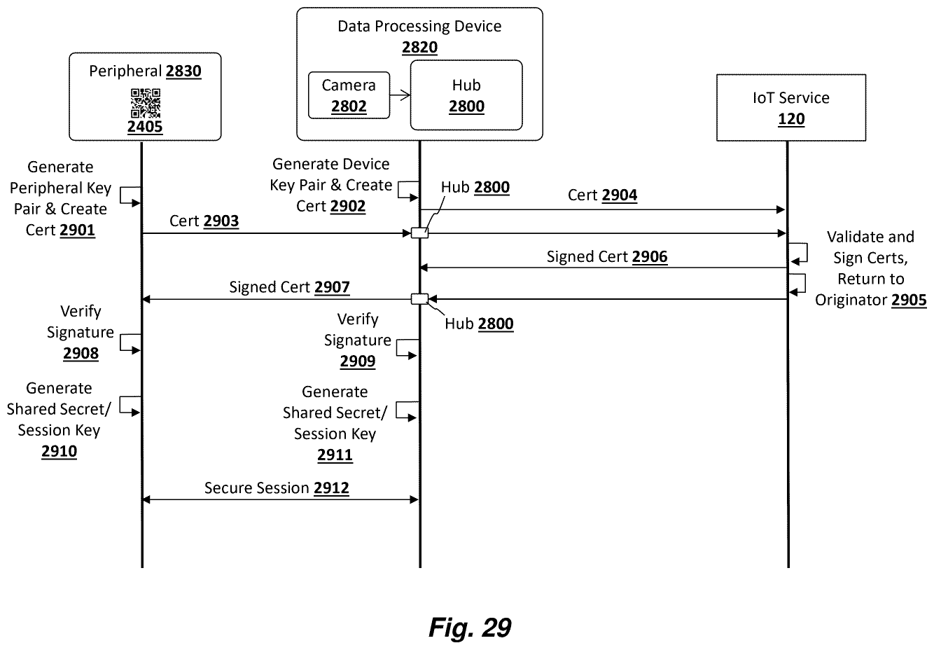

FIG. 29 illustrates a sequence of transactions for pairing the peripheral 2830 with the data processing device 2820 in accordance with one implementation. Once the QR code 2405 has been verified (as described above), at 2901, the peripheral generates a key pair and an associated certificate 2901 (e.g., using the public key and device-specific code(s)). Similarly, at 2902, the data processing device 2820 generates a key pair and an associated certificate. At 2903 the peripheral certificate is transmitted to the IoT service 120 via the hub 2800 and, at 2904, the data processing device certificate is transmitted to the IoT service 120. At 2905, the IoT service 120 validates and signs each of the certificates and sends back the signed certificates back to the data processing device 2820 (at 2906) and peripheral 2830 (at 2907 via the hub 2800).

Once the signatures are verified by the peripheral 2830 and data processing device 2820, at 2908 and 2909, respectively, they each generate a shared secret at 2910 and 2911, respectively. For example, the peripheral 2830 may use its private key and the data processing device's public key to generate the secret and the data processing device 2820 may use its private key and the peripheral's public key to generate the secret. They each use the secret for a session key (either alone or in combination with other identification data) to establish a secure session at 2912.

Apparatus and Method for Pairing a User Input and/or Output Device with a Multimedia System

Some embodiments of the invention also include pairing techniques for securely pairing Bluetooth headphones and other Bluetooth devices to multimedia systems such as those used in passenger planes and/or rental cars.

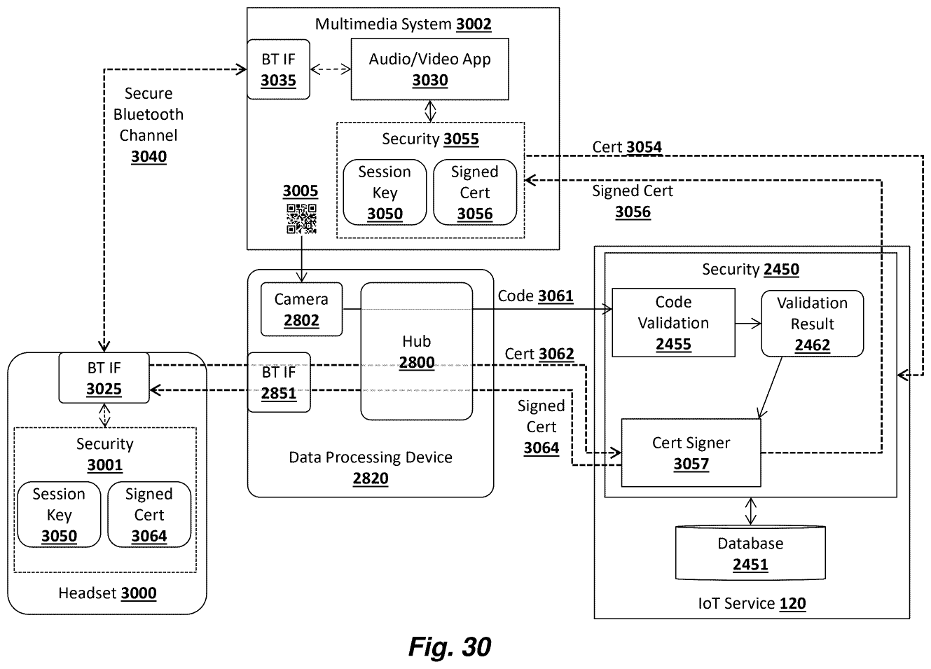

FIG. 30 illustrates one embodiment which pairs a Bluetooth headset 3000 with a multimedia system 3002 using a data processing device 2820 and the IoT service 120. The headset 3000 includes a Bluetooth interface 3025 capable of establishing Bluetooth links to the Bluetooth interface 2851 of the data processing device 2820 and the Bluetooth interface 3035 of the multimedia system 3002. Communication between the headset 3000 and the IoT service 120 is facilitated by the hub 2800 running on the data processing device 2820.

In operation, the user captures a code 3061 from a QR code 3005 either printed on the multimedia system or within the GUI of an audio/video app 3030 presented on a display of the multimedia system 3002. Code validation logic 2455 of the IoT service security subsystem 2450 validates the code 3061 to verify the authenticity of the multimedia system 3002, as indicated in a validation result 2462. For example, in one embodiment, all such multimedia systems 3002 are pre-registered with the IoT service 120 and assigned a unique identifier and signature using a factory key.

Once validated, the security subsystem 3055 of the multimedia system 3002 and the security subsystem 3001 of the headset 3000 each generate public/private key pairs and corresponding certificates 3054, 3062 using a combination of the public key and device-specific data. For example, the security subsystem 3055 combines its generated public key with the multimedia system's MAC address and/or device ID to generate the certificate 3054 and the security subsystem 3001 of the headset combines it's generated public key with the headset's MAC address and/or UUID to generate the corresponding certificate 3062.

The certificates are sent to certificate signer logic 3057 in the IoT service security subsystem 2450 which validates and generates a signature over the headset and multimedia system certificates, returned as signed certificates 3056, 3064. The security subsystem 3001 of the headset 3000 and security subsystem 3055 of the multimedia system 3002 then use the key pairs to securely generate and share a secret, which is used to produce the session key 3050 for a secure Bluetooth channel 3040 (e.g., used as the session key or used in combination with other identification data to produce the session key). As described above, the headset security logic 3001 may generate the session key using its private key and the multimedia system's public key while the multimedia system security logic 3055 may generate the session key using its private key and the headset's public key. In one implementation, the shared session key 3050 is then used by either side to encrypt/decrypt communication over the channel 3040.

In an alternate implementation, the data processing device 2820 performs one or more of the operations described above on behalf of the headset 3000, including generating the key pairs, verifying the signature provided by the IoT service 120, and/or generating the session key. It then securely provides the session key 3050 to the headset 3000 over a previously established secure Bluetooth link to allow the headset 3000 to establish the Bluetooth channel with the multimedia system 3002.

Thus, by using the IoT service 120 as a trusted intermediary, the headset 3000 can be efficiently and securely paired with the multimedia system 3002 simply by capturing the QR code 3005 via the camera 2802 of the data processing device 2820. This is in contrast to current implementations of the multimedia system 3002, which either do not provide Bluetooth connectivity and/or which transmit at least some unencrypted information in the clear.

Some embodiments of the invention operate in an “offline” mode in which one or both of the data processing device 2820 and multimedia system 3002 are disconnected from the IoT service 120. For example, the multimedia system 2003 may be in a passenger transportation vehicle such as a passenger jet, bus, or train, and may not remain continuously connected to the IoT service 120 when in transit. In one embodiment, the data processing device 2820 and/or the multimedia system 3002 may automatically enter into the offline mode when connectivity becomes unavailable. Alternatively, the data processing device 2820 and/or the multimedia system 3002 may operate in a single mode which does not require an active, continuous connection to the IoT service 120.

In these embodiments, the data processing device 2820 may include an instance or client-side version of the code validation logic 2455 which validates the code 3061 using authentication data pre-loaded from the IoT service 120. Thus, the authenticity of the multimedia system 3002 can be validated even when the data processing device 2820 does not have an active connection with the IoT Service 120.

In addition, in one embodiment, the multimedia system 3002 generates a plurality of unsigned certificates 3054 when a connection to the IoT service 120 is established and opportunistically requests signatures from the IoT service 120. The certificate signer 3057 of the IoT service 120 signs the certificates and sends the signed certificates 3064 to the multimedia system for later use, such as when the multimedia system 3002 and/or data processing device 2820 are unable to communicate with the IoT Service 120. These signed certificates 3064 may be designated as single use certificates on the multimedia system 3002 to maintain a high level of security. Consequently, multimedia systems that are in public places and passenger transportation vehicles may be pre-loaded with signed certificates when in connection with the IoT service 120, which can be used any time. In one embodiment, the multimedia system 3002 may store a minimum threshold number of signed certificates locally and automatically request additional signed certificates from the IoT service 120 as needed to keep the local number above the minimum threshold. When the number of locally stored signed certificates drops below the minimum number, the multimedia system 3002 automatically requests additional signed certificates from the IoT service 120 the next time a connection can be made.

### Apparatus and Method for Securing Sensitive Customer Information and Data

In some embodiments of the invention, to protect user privacy, any audio/video content captured by IoT devices and stored on the IoT service is encrypted using a key which is not available to the IoT service. The IoT service is therefore incapable of decrypting this audio/video content.

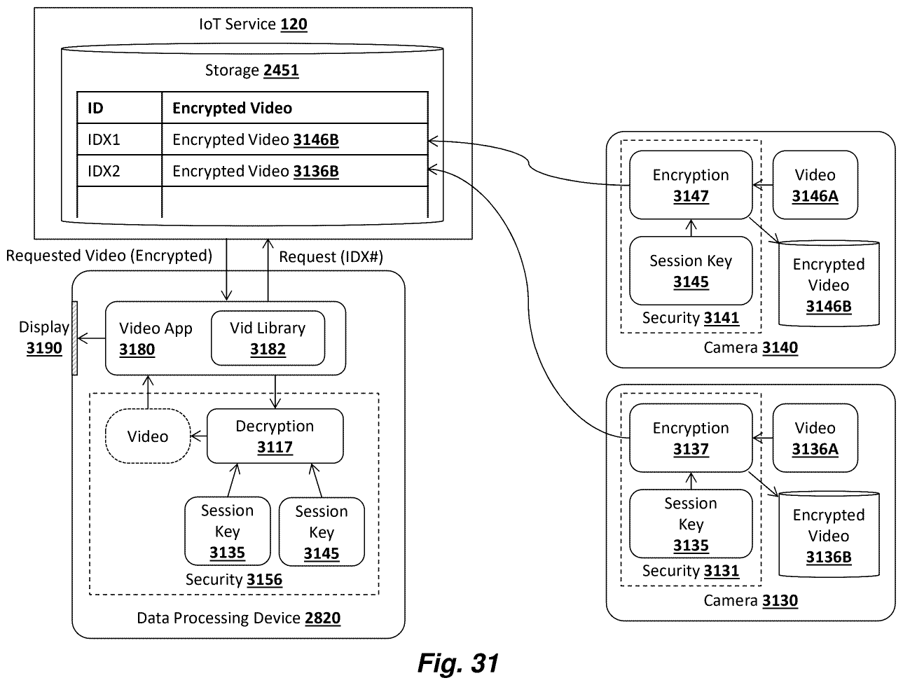

FIG. 31 illustrates one embodiment in which a plurality of cameras 3130 and 3140 associated with a user account on the IoT service 120 capture and encrypt video using per-camera session keys 3135 and 3145, respectively, negotiated with security logic 3156 on the data processing device 2820. The session keys 3135, 3145 may be generated using one or more of the techniques previously described (e.g., using the IoT service as an intermediary which validates certificates from both sides). Thus, encryption logic 3137, 3147 within each respective security subsystem 3131, 3141, uniquely encrypts the video 3136A, 3146B captured by each respective camera 3130, 3140, resulting in a plurality of video segments 3146A, 3146B encrypted with unique, camera-specific session keys and stored on persistent storage 2451 on the IoT service 120. As illustrated, the encrypted video segments 3146A, 3146B may also be stored on each respective camera 3130, 3140. Because the IoT service 120 does not have access to the session keys 3135, 3145, it is incapable of decrypting the video segments 3146A, 3146B, resulting in a heightened layer of privacy protection.

The data security subsystem 3156 of the data processing device 2820 includes copies of each session key 3135, 3145 associated with each camera 3130, 3140, respectively, so that the user can request and play back the corresponding video segments or display a live stream of images from a given camera. In either case, decryption logic 3117 of the security subsystem 3156 identifies the appropriate session key 3135, 3145 to perform the decryption based on the identity of the requested video segment.

In one embodiment, a video library 3182 managed by a video app 3180 on the data processing device 2820 maintains indices/offsets (or other location/identification data) associated with each encrypted video segment 3136B, 3146B and also maintains an association between each encrypted video segment and a particular session key 3135, 3145, or camera. In response to a user request to play a video segment, the video app 3180 transmits requests to the IoT service 120 with these indices/offsets (or other identifying information) that allow the IoT service 120 to locate the requested encrypted video 3136B, 3146B within the storage device 2451 and send it to the video app 3180, which uses the decryption logic 3117 in combination with the associated session key 3135, 3145 to decrypt and render the video on a display 3190.

Thus, the video content captured by the user's cameras 3130, 3140 is protected from a security breach at the IoT service 120, because the IoT service does not have access to the per-camera session keys 3135, 3145.

While this implementation improves security, it also has the potential to limit the features and user support offered by the IoT service 120. For example, if the user needs technical assistance with one of the cameras, the video stream associated with the camera cannot be shared with tech support personnel. In addition, without the ability to decrypt the video streams captured by the cameras, the IoT service cannot itself provide services such as object and facial recognition to categorize and organize the user's captured video segments. In these implementations, however, object and facial recognition may be performed on the camera 3130 and authorized data processing devices 2820.

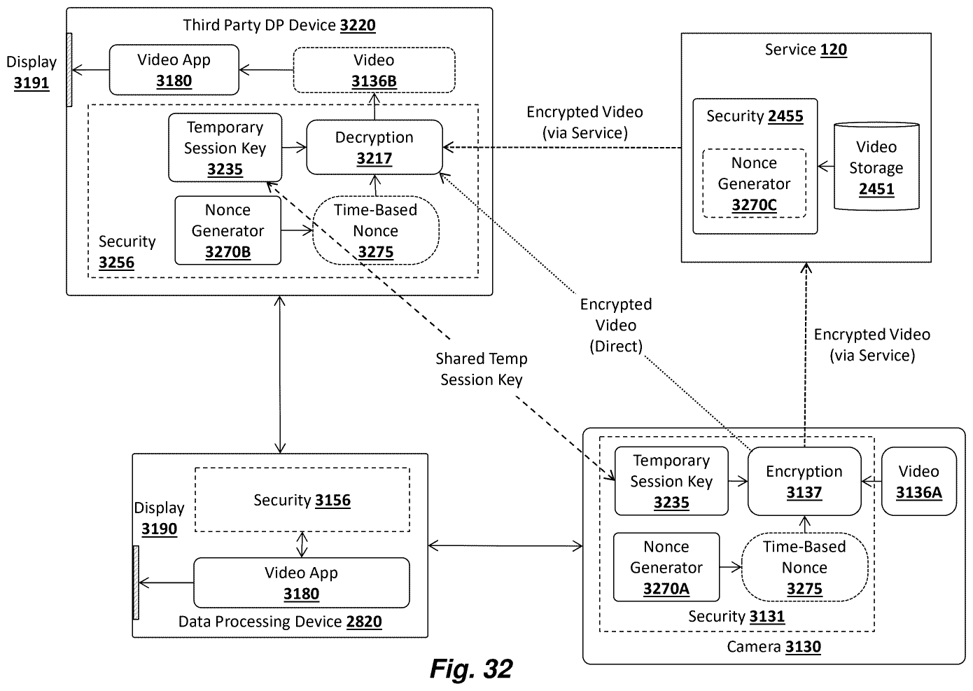

FIG. 32 illustrates one embodiment of a system for temporarily providing access to the video segments to a third party data processing device 3220 (e.g., for the purpose of providing technical assistance to the user). In this embodiment, the security subsystem 3131 of the camera 3130 and the security subsystem 3256 of the data processing device 3220 either negotiate a temporary session key 3235 (e.g., using the techniques previously described) or one of the security subsystems 3131, 3156 creates the temporary session key 3235 and shares it with the security subsystem 3256 of the third party data processing device 3220.

In one implementation, encryption logic 3137 of the security subsystem 3131 uses the temporary session key 3235 combined with a time-based nonce 3275 generated by a nonce generator 3270A to encrypt the video 3136A. The resulting encrypted video can then only be decrypted for a period of time in which the time-based nonce 3275 is valid (e.g., a few minutes, an hour, etc).

The security subsystem 3256 of the data processing device 3220 includes a corresponding nonce generator 3270B which independently generates the time-based nonce 3275. Decryption logic 3217 then uses the shared temporary session key 3235 and the time-based nonce 3275 to decrypt the video 3136B (assuming that the nonce 3275 is still valid), which may be rendered on a display 3191 by a video app 3180. When the period of time associated with the time-based nonce 3275 has expired, the time-based nonce 3275 is no longer valid and the decryption logic 3217 will be unable to decrypt the video. In some embodiments, protection mechanisms are used to ensure that the time based nonce cannot be persistently stored.

As indicated in FIG. 32, the encrypted video stream may either be transmitted to the third party data processing device 3220 directly, or via the IoT service 120 (e.g., over a previously-established secure connection with the IoT service 120).

In some implementations, rather than running a separate nonce generator 3270A-B on each of the cameras 3130 and data processing devices 3220, a single nonce generator 3270C is operated on the IoT service 120. When a nonce is required for encryption/decryption operations as described here, the security subsystems 3131, 3256 of each respective device request the current nonce from the security subsystem 2455 of the IoT service 120 rather than generating it independently.

In some embodiments, the operations associated with generating a temporary session key and a time-based nonce are performed by the security subsystem 3156 on the user's data processing device 2820 rather than the camera 3130. In this embodiment, all of the components of the camera security subsystem 3131 including the nonce generator 3270A, temporary session key 3235 and encryption logic 3137 are implemented within the data processing device security subsystem 3156.

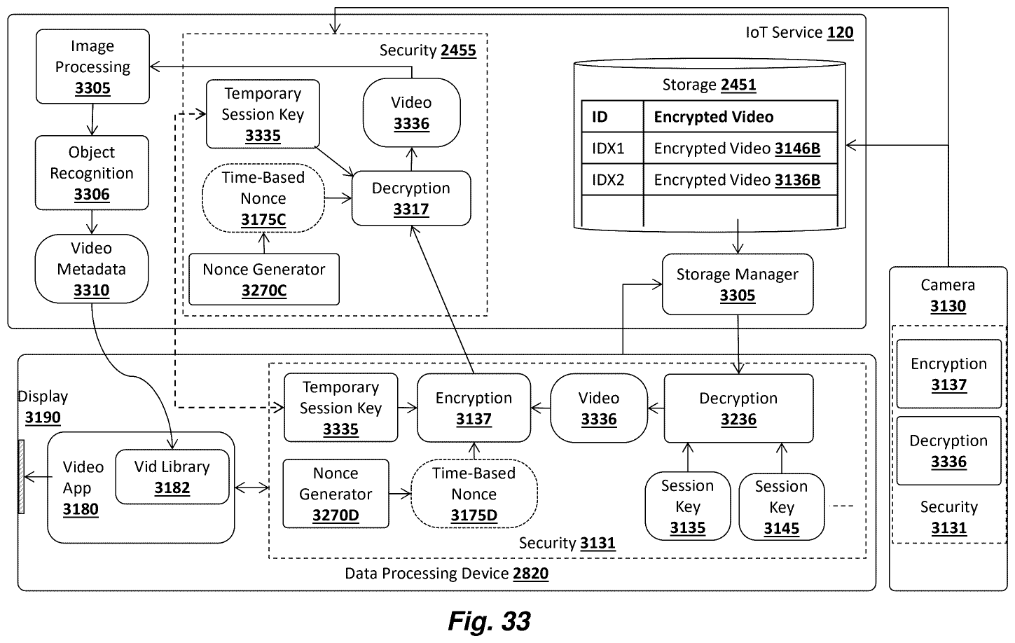

FIG. 33 illustrates another embodiment of a system for temporarily providing access to encrypted video. As mentioned, a variety of separately-encrypted video segments 3136B, 3146B may be stored within persistent storage 2451 on the IoT service 120, which is incapable of decrypting these encrypted video segments because it does not have access to the associated session keys. While this functionality provides an extra layer of privacy protection, it prevents the IoT service 120 from providing services to the end user, such as image processing and object/facial recognition.

One embodiment of the invention provides for temporary decryption of the user's video segments so that these additional services can be provided. In this embodiment, the user can select all or a subset of encrypted video segments 3136B, 3146B for these enhanced services via the video library 3182 of the video app 3180. In response, the data processing device 2820 requests one or more of the video segments via the storage manager 3305 on the IoT service 120. As mentioned, the request may comprise a sequence of index or offset values which uniquely identifies the location of the encrypted video segments 3136B, 3146B.

Decryption logic 3236 within the security subsystem 3131 decrypts the video segments using the corresponding session keys 3145, 3135 to generate the underlying video segments 3336. Encryption logic 3137 then re-encrypts the video using a time-based nonce 3175D generated by a nonce generator 3270D and a temporary session key 3335. Alternatively, or in addition, the security logic 3131 of the camera 3130 performs these operations. For example, decryption logic 3336 on the camera may decrypt the video and encryption logic 3137 may re-encrypt the video using a time-based nonce generated by a nonce generator and a temporary session key. While not illustrated within the camera 3130 for simplicity, these components operate in substantially the same manner as described for the data processing device 2820. For example, the camera 3130 of this embodiment includes a nonce generator 3270D for generating a time-based nonce 3175D which the encryption logic 3137 uses in combination with the temporary session key 3335 to generate the encrypted video. Alternatively, or in addition, the encryption logic 3137 in the camera 3130 may use the temporary session key 3335 and time-based nonce 3175D to encrypt unencrypted video (rather than first decrypting encrypted video). In this embodiment, the unencrypted video may be the video captured by the camera and/or temporarily stored on the camera 3130 prior to encryption.

As previously described, the temporary session key 3335 may be negotiated between the security subsystem 2455 of the IoT service 120 and the security subsystem 3131 of the data processing device 2820 using the various techniques for generating session keys described above. Alternatively, the temporary session key 3335 may be generated by one of the security subsystems and shared with the other.

Decryption logic 3317 of the IoT service security subsystem 2455 then decrypts the video 3336 using the time-based nonce 3175 generated by nonce generator 3270C and the temporary session key 3335, assuming that the time-based nonce is still valid. Once the time-based nonce expires, the decryption logic 3317 will be unable to decrypt the video.

Once the video 3336 is decrypted, image processing logic 3305 on the IoT service 120 can provide additional user services, including various forms of image processing. For example, the image processing logic 3305 may perform operations to improve the quality of the video or to normalize the video to a particular resolution for further processing. In one embodiment, object recognition logic 3306 implements machine-learning or other techniques to identify objects or faces within each video segment, and stores these results in video metadata 3310 associated with the video segment. In one embodiment, for example, the video metadata 3310 may be sent to the video library 3182 on the video app 3180 and linked to the related video segments within the library.

### Systems and Methods for Camera Security

Embodiments of the invention described below include additional security-related features to ensure that the IoT cameras and associated captured video sequences are protected in a variety of circumstances including, but not limited to, an initial onboarding of the IoT camera, event recordings captured and streamed to the IoT service, the loss of the user's mobile device and/or addition of a second mobile device, changes to a user's account credentials, and stolen cameras.

These embodiments rely on asymmetric Key Encryption Keys (KEK) pairs which encrypt the Data Encryption keys (DEKs) used to encrypt captured video. As in prior embodiments, the IoT service (aka, the “cloud”) is not provided access to any of the asymmetric key pairs. In these embodiments, each camera has a unique asymmetric key pair (KEK) negotiated with the application on the user's mobile device, which is capable of supporting a specified number (n) of KEK pairs for each camera and which allows the KEK keys to be rotated. In some embodiments, the KEK keys are time bound by creation/inception and expiration times and, in some implementations, allow for a time to live (TTL) value for each key pair. While the IoT service does not have access to the KEK pairs, it may signal to the application and cameras to refresh the asymmetric key pairs (KEK) periodically and/or in response to events.

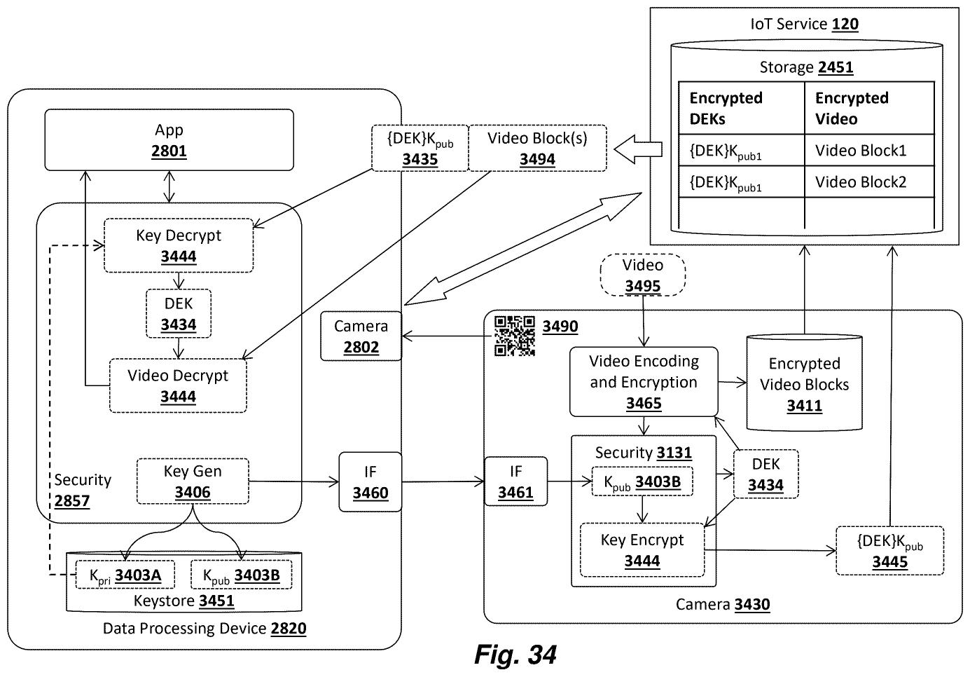

Referring to FIG. 34, in these embodiments, in the initial unboxed state, neither the camera 3430 nor the application 2801 will not have any key material to encrypt the videos. To onboard the camera 3430 (i.e., install and associate the camera with the user's account on the IoT service 120), the user indicates installation of a new device in the app 2801, which prompts the user to scan the camera QR code 3490 via the camera 2802 of the user's data processing device 2820. The camera is then connected to the user's account using various embodiments described above. For example, once the QR code 3490 is verified, separate public/private key pairs and corresponding certificates are generated (e.g., using a combination of the public key and device-specific data) as described above. The certificates are sent to the IoT service 120 which validates and generates a signature over the certificates (e.g., signing the certificates with the IoT service private key) and returns the signed certificates to the application 2801 and camera 3430. Once validated, the security subsystem 3130 of the camera and the security subsystem 2857 of the data processing device 2820 use the key pairs to securely generate and share a secret, which is used to produce the session key for secure communication between the data processing device 2820 and camera 3430 via a local wireless communication channel (e.g., Bluetooth).

Once the camera 3430 is connected to the user's account on the IoT service 120 then the camera generates key material as described below. Note that the various keys described here are different from the keys used in the onboarding process described above.

In some embodiments, the private Key Encryption Keys (KEKs) only exist within the security subsystem 2857 of the user's data processing device 2820, which can be any device capable of executing the application 2801. This is done to ensure that only the user has access to the video segments captured by the user's cameras. In this embodiment, the app 2801 generates a KEK public key (Kpub) and private key (Kpri) pair. For example, the app 2801 may make a call to the security subsystem 2857 and key generation logic 3406 of the security subsystem generates the KEK key pair 3403A-B and stores at least Kpri 3403A in the secure keystore 3451. In one embodiment, the key generation logic 3406 uses Elliptic-curve Cryptography (ECC) with a key size of 256 bits, although the underlying principles of the invention are not limited to any particular cryptography standard.

In some embodiments, the application 2801 is configured to generate different sets of KEK pairs for each camera 3430, which are stored in the device's secure keystore 3451. Once generated, the KEK pairs may be rotated/changed based on a schedule. When new KEK pairs are generated, the old KEK pairs are maintained to decrypt video segments captured when the old KEK pairs were valid. In some embodiments, because video segments are only maintained for a limited time on the IoT service 120, the old key-pairs may be aged out based on this schedule. If a user wants a copy of a video beyond the online storage date, they can download it to the data processing device which will decrypt it and store it locally.

Using a unique asymmetric key pair for each combination of an application 2801 and camera 3430 provides an extra layer of security. For example, if a camera is compromised, the threat actors will not gain access to any other video produced by any other camera in the user's account.

In the illustrated implementation, the application 2801 shares the public key (K_{pub}) with the camera 3430 (e.g., via the security subsystem 2857) over the secure wireless channel produced via the camera onboarding process and using wireless interfaces 3460-3461 of the device and camera, respectively.

When the camera 3430 starts recording video 3495, such as in response to a defined event (e.g., person identified, animal identified, etc), video encoding and encryption logic 3465 encodes the video in accordance with a particular video standard (e.g., HTTP Live Stream (HLS)) and the security subsystem 3131 generates a unique symmetric key 3434, referred to as the data encryption key (DEK) 3434, for encrypting the video into encrypted video blocks 3411. In some implementations, the security subsystem 3131 generates a unique symmetric key for each new video event. The video may be chunked into a plurality of 1-second blocks, each of which is encrypted with the dynamically-generated DEK to produce the encrypted video blocks 3411.

Each 1-second video block 3411 may be saved as a separate file (e.g., a *.ts file if HLS is used for encoding) in a FIFO RAM cache on the camera 3430 until they are uploaded to the IoT service 120. Depending on the implementation, there may be a maximum number of video blocks/files 3411 for each video event (e.g., 128, 256, etc), after which a new video event is started with a newly-generated DEK if additional recording is required (e.g., due to continued motion in view of the camera).

In one implementation, the video encoding and encryption logic 3465 generates or replaces a manifest file after each video file is encoded (e.g., an m3u8 manifest for HLS). The manifest file includes information related to the sequence of video files, including an indication of the last video file in the video segment. In some embodiments, the manifest file has a pointer (e.g., a URI) to a file that contains the encrypted DEK.

In some embodiments, the video encoding and encryption logic 3465 can dynamically adjust the video encoding/compression bitrate based on the detected upload speed to the IoT service 120. For example, the camera may dynamically check the upload speed periodically (e.g., every second, every few seconds, etc) and drop the bitrate in response to detecting that the upload speed is below a specified threshold. The particular threshold may depend on the amount of local buffer storage available in the camera 3430.

In one implementation, the camera 3430 starts uploading to the IoT service 120 as soon as the first encrypted video file 3411 for an event is created (e.g., the first .ts file if HLS is used). When the video file is successfully uploaded, it may be deleted from the camera 3430 to free space for subsequent video files. The IoT service 120 may transmit a notification to the camera 3430 after each file is successfully uploaded. In response to a failure, the camera 3430 may reattempt to upload the video file.

In one embodiment, key encryption logic 3444 uses the public KEK key (K_{pub}) 3403B to encrypt each DEK 3434 and generate a corresponding encrypted DEK 3445, {DEK}K_{pub}, which is uploaded to the IoT service 120 along with the corresponding compressed and encoded video files. Consequently, only a device which has access to the private KEK key (Kₚᵣᵢ) 3403A can decrypt the DEK and use it to decrypt the corresponding video. Thus, if the private KEK 3403A is only stored on the user's data processing device 2820, as in some embodiments, only the user can decrypt and view the video.

In the illustrated example, the security subsystem 2857 of the user's data processing device 2820 includes key decryption logic 3444 to decrypt the encrypted DEK ({DEK}K_{pub}) 3435 using the private KEK key (Kₚᵣᵢ) to produce the unencrypted DEK 3434. Video decryption logic 3444 then uses the unencrypted DEK 3434 to decrypt the corresponding video blocks 3494 and provide the unencrypted video to the app 3801 for decoding and rendering on a display of the data processing device 2820.

The video decryption logic 3444 can use the decrypted DEK 3434 for all video blocks 3494 which the video encoding and encryption logic 3465 encrypted with the DEK 3434. When the DEK 3434 changes (e.g., when a new video sequence is accessed), the same set of operations are repeated—i.e., key decryption logic 3444 decrypts the new DEK and uses the unencrypted DEK to decrypt the new video blocks.

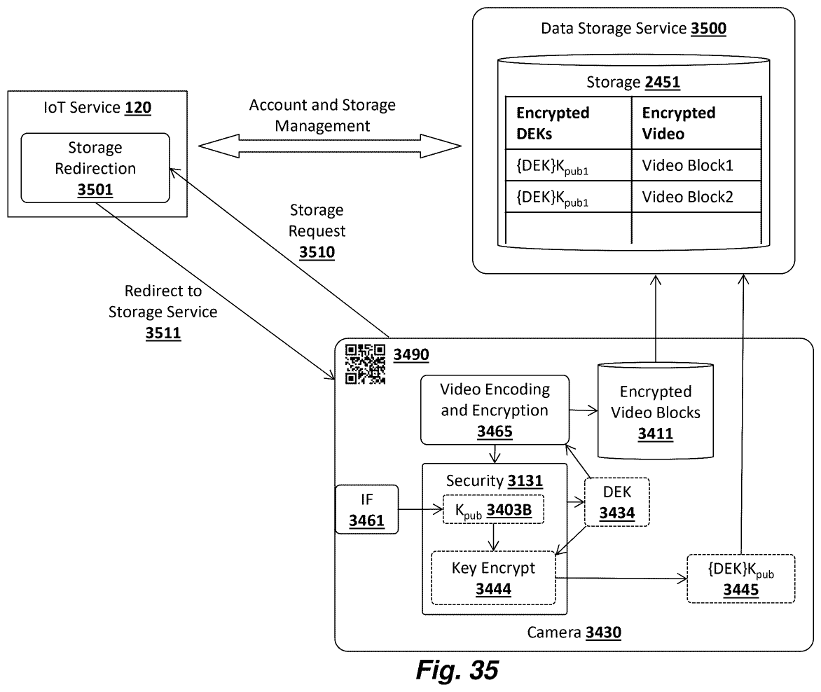

While FIG. 34 illustrates video blocks being stored within a storage facility 2451 of the IoT service 120, in some implementations, a third party data storage service is used, such as data storage service 3500 in FIG. 35. In operation, the camera transmits a storage request 3510 to the IoT service 120 (e.g., in response to new video blocks to be uploaded) and storage redirection logic 3501 transmits a response 3511 redirecting the camera 3430 to a network location operated by the data storage service 3500 on behalf of the IoT service 120. User data processing devices may similarly be redirected to the data storage service 3500 to play back the video blocks.

In one particular embodiments, the Amazon Simple Storage Service (Amazon S3) is used for the data storage service 3500. In this embodiment, the camera 3430 asks the IoT service 120 (e.g., via a KSP request message) for a storage location in an S3 bucket, passed via a path through the CloudFront content delivery network with a time limited hash-based message authentication code (HMAC) credential. By way of example, and not limitation, the CDN/S3 location may be specified using the format:

$$https : // [ CDN\_ROOT \_URL ] / a / [ ACCOUNT\_ID ] / d / [ DEVICE\_ID ] / e / [ UNIQUE\_EVENT \_UUID ] {/}^{*}$$

Cloud generates a single use IAM policy document, that defines the specific event path, the required source IP of the camera, and an expiration date of the credential. That policy is signed with a private key, and encoded into the resulting credential HMAC returned to the client. The following is a sample policy document before HMAC encoding:

“Resource”:“https://d3hli9ozzdr244.cloudfront.net/a/f0d30d02-7d2f-4977-
9145-c7d1f99925d7/d/8fda40f52061b896/e/8c6bcb9b-5294-41ba-b5df-
75cbd78a91dd/*”,
“Condition”: {“DateLessThan”:
{“AWS:EpochTime”:1688854571},“IpAddress”: {“AWS:SourceIp”:
“24.23.253.151/32”}}
C → CDN → S3 : { V : {ts0}DEK ,..., {tsn}DEK }

Note, however, these specific details are not required for complying with the underlying principles of the invention.

When a camera 3430 detects an event and begins recording, it may transmit a notification to the user's data processing device 2820. The app 2801 may provide the user with an option to view a live video stream from the camera 3430. When this option is selected by the user, it would be undesirable to allow gaps to appear in the recorded video (e.g., due to the inability of the camera 3430 to concurrently send the live stream and continue to record the event).

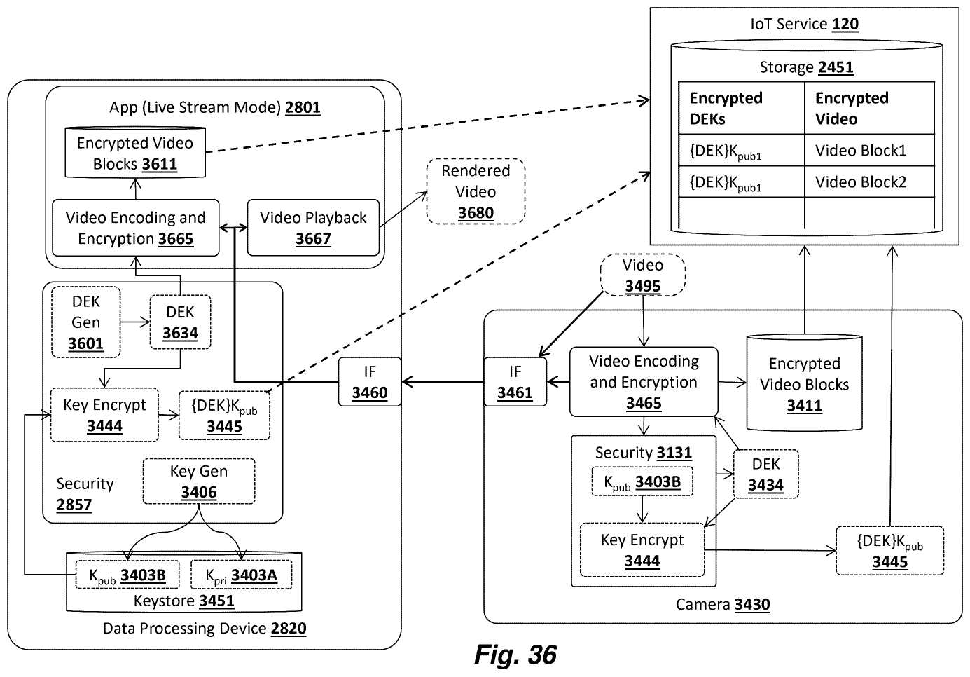

In one embodiment illustrated in FIG. 36, when the camera 3430 is in the process of generating the encrypted video blocks 3411 for storage and the user selects the live stream option from the app 2801, the raw digitized video 3495 is streamed to the app 2801, which includes video playback logic 3667 for rendering the video 3680 and video encoding and encryption logic 3665 for encoding and encrypting the video to generate encrypted video blocks 3611 (as described above with resect to the camera 3430).

The security subsystem 2857 of the data processing device 2820 includes DEK generation logic 3601 for generating a DEK 3634 (e.g., using Elliptic-curve Cryptography (ECC) as previously described), which the video encoding and encryption logic 3665 uses to encrypt the video blocks 3611. Key encryption logic 3444 uses the public KEK key (K_{pub}) 3403B to encrypt the DEK key 3694 to generate an encrypted DEK key, {DEK}K_{pub} 3445. The app 2801 transmits the encrypted video blocks 3611 and the encrypted DEK 3445 to the IoT service 120 or the data storage service 3500 (in response to a redirection), as previously described with respect to the encoding and encryption performed by the camera 3430.

While FIG. 36 shows the video 3495 being streamed via the wireless interfaces 3460-3461 for simplicity, the camera 3430 may stream the video to the app 2801 via the local wireless network (e.g., via a WiFi router) or through the IoT service 120 which has a secure connection to the app 2801. However, depending on the implementation, a direct connection via local wireless interfaces 3460-3461 can also be used.

Thus, during the time when the user is viewing the live video stream, the camera 3430 stops recording and transitions to providing the live stream to the app 2801, which performs both video recording for the live stream and video encoding/compression for recording. When the user disables viewing of the live stream, the camera 3430 may return to recording the video and generating corresponding video blocks 3411 as previously described. Consequently, the corresponding event includes video blocks encrypted and encoded by the camera 3430 (using the camera-generated DEK 3434) and video blocks encrypted and encoded by the app 2801 (using the device-generated DEK 3634). When a user plays this video back from the data processing device 2820, both DEKs 3434, 3634 are decrypted with the same private KEK key 3403A, and are then used to decrypt the corresponding video blocks.

When an S3 data storage implementation is used for the data storage service 3500, as previously described, the application 2801 may create a new recorded event in the S3 bucket—as if the camera had created it directly, recording the live video it is rendering for the user and uploading the encrypted video blocks 3611 to the cloud with the corresponding {DEK}K_{pub} 3445. In some implementations, the video may also be keyed as if it had originally come directly from the camera 3430.

In various embodiments described herein, the keystore 3451 in which the private key (Kₚᵣᵢ) is stored is automatically backed up by the provider of the data processing device 2820. For example, iPhone keychain data is automatically backed up in iCloud Keychain Sync and Android keystore is backed up in Google's Credential Manager. Thus, if a user's device is lost or stolen, or if the user replaces the device, the private key (Kₚᵣᵢ) can be recovered from these backups. One embodiment of the app 2801 instructs the user to enable keystore/keychain backups on the data processing device 2820 and generates notifications if it detects that keystore/keychain backups are not enabled.

In some embodiment, a user can add a second data processing device to the user's account which will have access to all cameras and recorded video. On the new device, the user installs the app, and authenticates with the IoT service 120 to associate the new installation with the user's account and establish a secure connection with the IoT service 120. The app may instruct the user to transfer the public/private keys from the old data processing device 2820. On the original data processing device 2820, the user may select an option to transfer the KEK private key (Kpri) 3403A and public key (Kpub) 3403B to the new device (e.g., via an application prompt/notification, or via a selectable menu option). In response, the security subsystem 2857 on the initial data processing device 2820 may generate an optical QR code on the data processing device display containing an encoded representation of the KEK private key (Kpri) and public key (Kpub). The user scans the QR code from the new data processing device to securely transfer the keys into that device's secure keystore.

Alternatively, or additionally, a secure transfer may be performed via local wireless channels between the two devices, which can include Near Field Communication (NFC) channels, Bluetooth channels, and/or WiFi channels. Options for secure transfer may also be provided by the operating system of the data processing devices, such as Apple air-drop, which uses one or more of these short-range wireless protocols. As another option, the KEK private key (Kpri) and public key (Kpub) may be securely transferred through the IoT service 120 to the new data processing device, via the secure communication channel established with the app 2801 following authentication of the user.

In some embodiments, the original data processing device generates new keys, shares them with the cameras 3430 and with the new device, to be used to perform encryption for all subsequent video recordings.

As mentioned, in some embodiments, the DEK key 3434 is not persistently stored on the camera 3430—i.e., will only exist in volatile memory during the video recording process, and is only used for one video event. The public key Kpub is public and does not need to be kept secret.

Some embodiments allow individual cameras or a group of cameras to be shared with another user account. For example, via the app 2801, the user identifies the other account with which to share each individual camera (e.g., via an account email address, phone number, etc). The user of the other account then receives a notification via their app 2801 that the camera(s) have been shared and accepts the share invitation. The private KEK key 3403A may be transferred to the other user's data processing device using any of the techniques described above for sharing the KEK key 3403A with a new device (e.g., via a QR code, local wireless communication, or via the IoT service 120).

In some embodiment, the other user is not granted access to previously-recorded videos, unless such videos are specifically identified by the user to be shared. These options are configured via a set of permissions associated with each video and each camera 3430 (e.g., indicating if shared and, if so, with which user(s)).

As one example, a user who owns a home with a camera may share the camera with another user who is renting the home. In this example, the owner may specify via a set of permissions, that the renter can have access to the cameras and associated video only during the period of time of the rental. Thus, when the rental ends, access to the cameras and video is automatically revoked via modification of the corresponding permissions.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals-such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. A method, comprising:
generating a key pair comprising a private key and a public key;
storing at least the private key on a data processing device of a user and storing only the public key on an internet of things (IoT) camera associated with an account of a user;
in response to an event, the IoT camera to perform the operations of:
generating a temporary data encryption key (DEK);
encrypting video captured by the camera using the DEK to generated encrypted video blocks;
encrypting the DEK using the public key to generate an encrypted DEK; and
transmitting the encrypted video blocks and the encrypted DEK to a video storage service.

2. The method of claim 1, further comprising:
receiving an indication to play back the encrypted video blocks on the data processing device;
downloading or streaming the encrypted video blocks and the encrypted DEK from the storage service;
using the private key to decrypt the encrypted DEK to produce the DEK;
using the DEK to decrypt the encrypted video blocks for rendering on the data processing device.

3. The method of claim 2 wherein the data processing device generates the key pair in response to an IoT app executed on the data processing device, and shares the public key with the IoT camera.

4. The method of claim 3 wherein the IoT app initially associates the IoT camera with an account of the user on an IoT service and establishes a secure communication channel with the IoT camera to provide the public key to the IoT camera.

5. The method of claim 1 wherein the event comprises a first event, the DEK comprises a first DEK, the encrypted DEK comprises a first encrypted DEK, the video comprises a first video, and the encrypted video blocks comprise first encrypted video blocks, the method further comprising:
in response to a second event, the IoT camera to perform the operations of:
generating a second temporary data encryption key (DEK);
encrypting second video captured by the IoT camera using the second DEK to generated second encrypted video blocks;
encrypting the second DEK using the public key to generate a second encrypted DEK; and
transmitting the second encrypted video blocks and the second encrypted DEK to a video storage service.

6. The method of claim 5 wherein the video storage service is to perform the operations of:
associating the first encrypted DEK with the first encrypted video blocks and associating the second encrypted DEK with the second encrypted video blocks;
responsive to requests from the data processing device, transmitting either the first encrypted DEK with the first encrypted video blocks or transmitting the second encrypted DEK with the second encrypted video blocks to the data processing device.

7. The method of claim 1 wherein the video storage service comprises: an IoT service operated by the provider of the IoT camera, or a third party storage service used by the IoT service to store encrypted video blocks captured by the IoT camera.

8. The method of claim 1 further comprising:
receiving, by the IoT camera, an indication that a live video stream is to be sent to the data processing device and responsively forwarding the live video stream captured by the IoT camera to the data processing device;
wherein in response to receiving the live video stream, the data processing device is to perform operations, comprising:
rendering the live video stream for viewing by the user;
generating a second data encryption key (DEK);
encrypting the live video stream using the second DEK to generated second encrypted video blocks;
encrypting the second DEK using the public key to generate a second encrypted DEK; and
transmitting the second encrypted video blocks to the video storage service, wherein the video storage service is to associate the second encrypted video blocks with the second encrypted DEK.

9. A machine-readable medium having program code stored thereon which, when executed by one or more processors, causes the one or more processors to perform the operations of:
generating a key pair comprising a private key and a public key;
storing at least the private key on a data processing device of a user and storing only the public key on an internet of things (IoT) camera associated with an account of a user;
in response to an event, the IoT camera to perform the operations of:
generating a temporary data encryption key (DEK);
encrypting video captured by the camera using the DEK to generated encrypted video blocks;
encrypting the DEK using the public key to generate an encrypted DEK; and
transmitting the encrypted video blocks and the encrypted DEK to a video storage service.

10. The machine-readable medium of claim 9, further comprising program code to perform the operations of:
receiving an indication to play back the encrypted video blocks on the data processing device;
downloading or streaming the encrypted video blocks and the encrypted DEK from the storage service;
using the private key to decrypt the encrypted DEK to produce the DEK;
using the DEK to decrypt the encrypted video blocks for rendering on the data processing device.

11. The machine-readable medium of claim 10 wherein the data processing device generates the key pair in response to an IoT app executed on the data processing device, and shares the public key with the IoT camera.

12. The machine-readable medium of claim 11 wherein the IoT app initially associates the IoT camera with an account of the user on an IoT service and establishes a secure communication channel with the IoT camera to provide the public key to the IoT camera.

13. The machine-readable medium of claim 9 wherein the event comprises a first event, the DEK comprises a first DEK, the encrypted DEK comprises a first encrypted DEK, the video comprises a first video, and the encrypted video blocks comprise first encrypted video blocks, the machine-readable medium further comprising program code to perform the operations of:
in response to a second event, the IoT camera to perform the operations of:
generating a second temporary data encryption key (DEK);
encrypting second video captured by the IoT camera using the second DEK to generated second encrypted video blocks;
encrypting the second DEK using the public key to generate a second encrypted DEK; and
transmitting the second encrypted video blocks and the second encrypted DEK to a video storage service.

14. The machine-readable medium of claim 13 wherein the video storage service is to perform the operations of:
associating the first encrypted DEK with the first encrypted video blocks and associating the second encrypted DEK with the second encrypted video blocks;
responsive to requests from the data processing device, transmitting either the first encrypted DEK with the first encrypted video blocks or transmitting the second encrypted DEK with the second encrypted video blocks to the data processing device.

15. The machine-readable medium of claim 9 wherein the video storage service comprises: an IoT service operated by the provider of the IoT camera, or a third party storage service used by the IoT service to store encrypted video blocks captured by the IoT camera.

16. The machine-readable medium of claim 9 further comprising program code to perform the operations of:
receiving, by the IoT camera, an indication that a live video stream is to be sent to the data processing device and responsively forwarding the live video stream captured by the IoT camera to the data processing device;
wherein in response to receiving the live video stream, the data processing device is to perform operations, comprising:
rendering the live video stream for viewing by the user;
generating a second data encryption key (DEK);
encrypting the live video stream using the second DEK to generated second encrypted video blocks;
encrypting the second DEK using the public key to generate a second encrypted DEK; and
transmitting the second encrypted video blocks to the video storage service, wherein the video storage service is to associate the second encrypted video blocks with the second encrypted DEK.

17. A system, comprising:
a data processing device to generate a key pair comprising a private key and a public key, store at least the private key and share the public key with an internet of things (IoT) camera associated with an account of a user of the data processing device;
the IoT camera, in response to an event, to perform the operations of:
generating a temporary data encryption key (DEK);
encrypting video captured by the camera using the DEK to generated encrypted video blocks;
encrypting the DEK using the public key to generate an encrypted DEK; and
transmitting the encrypted video blocks and the encrypted DEK to a video storage service.

18. The system of claim 17, further comprising:
the data processing device, in response to an indication to play back the encrypted video blocks, downloading the encrypted video blocks and the encrypted DEK from the storage service;
a security subsystem of the data processing device using the private key to decrypt the encrypted DEK to produce the DEK, wherein the DEK is to be used to decrypt the encrypted video blocks for rendering on the data processing device.

19. The system of claim 18 wherein the data processing device is to generate the key pair in response to an IoT app executed on the data processing device, and to share the public key with the IoT camera.

20. The system of claim 19 wherein the IoT app is to initially associate the IoT camera with an account of the user on an IoT service and to establish a secure communication channel with the IoT camera to provide the public key to the IoT camera.

21. The system of claim 17 wherein the event comprises a first event, the DEK comprises a first DEK, the encrypted DEK comprises a first encrypted DEK, the video comprises a first video, and the encrypted video blocks comprise first encrypted video blocks, wherein the IoT camera, in response to a second event, is to:
generate a second temporary data encryption key (DEK);
encrypt second video captured by the IoT camera using the second DEK to generated second encrypted video blocks;
encrypt the second DEK using the public key to generate a second encrypted DEK; and
transmit the second encrypted video blocks and the second encrypted DEK to a video storage service.

22. The system of claim 21 wherein the video storage service is to:
associate the first encrypted DEK with the first encrypted video blocks and associating the second encrypted DEK with the second encrypted video blocks;
responsive to requests from the data processing device, transmit either the first encrypted DEK with the first encrypted video blocks or transmitting the second encrypted DEK with the second encrypted video blocks to the data processing device.

23. The system of claim 17 wherein the video storage service comprises an IoT service operated by the provider of the IoT camera, or a third party storage service used by the IoT service to store encrypted video blocks captured by the IoT camera.

24. The system of claim 17 wherein the IoT camera, in response to receiving an indication that a live video stream captured by the IoT camera is to be sent to the data processing device, to responsively forward the live video stream to the data processing device;
wherein in response to receiving the live video stream, the data processing device is to:
render the live video stream for viewing by the user;
generate a second data encryption key (DEK);
encrypt the live video stream using the second DEK to generated second encrypted video blocks;
encrypt the second DEK using the public key to generate a second encrypted DEK; and
transmit the second encrypted video blocks to the video storage service, wherein the video storage service is to associate the second encrypted video blocks with the second encrypted DEK.
